(19) United States
(12) Patent Application Publication
(10) Pub. No.: US 2012/0214416 A1
(43) Pub. Date: Aug. 23, 2012

(54) METHODS AND APPARATUSES FOR COMMUNICATION BETWEEN DEVICES

(76) Inventors: Jonathan Douglas Kent, San Francisco, CA (US); Keith Lazuka, San Francisco, CA (US); Ogden Gregory Kent, San Francisco, CA (US); Djordje Gluhovic, Oakland, CA (US)

(21) Appl. No.: 13/186,404

(22) Filed: Jul. 19, 2011

Related U.S. Application Data
(60) Provisional application No. 61/445,800, filed on Feb. 23, 2011.

(51) Int. Cl. H04W 4/00

(52) U.S. Cl. 455/41.2

(57) ABSTRACT

A method of communicating between at least two mobile devices in which the method comprises the steps of obtaining an invitation code and transforming the invitation code into a sound wave signal designed to be transmitted by a mobile device. After the invitation code is transformed into the sound wave signal, the sound wave signal is transmitted from a speaker of the mobile device. Additional mobile devices may receive the sound wave signal, resulting in a connection state between the devices.

This application claims the benefit of U.S. Provisional Application No. 61/445,800, filed Feb. 23, 2011, which is hereby incorporated by reference.

### FIELD

The present patent document relates to methods and apparatuses for communication between devices. In particular, the present patent document relates to methods and apparatuses for proximal communication between mobile devices using sound wave signals.

### BACKGROUND

The proliferation of mobile devices allow us to stay connected and constantly receive data in numerous formats including voice, data, web, email, text and various other methods. However, current methods associated with the use of mobile devices only allow their users to connect with other users of mobile devices that they already have contact information for or are already associated with thorough an account with a third party host. For example, you cannot call, text or send a message to a person sitting on the other side of the room unless you have the contact information for their mobile device and the related account.

In today's social world, numerous situations may arise where people in close proximity wish to form a connection and exchange information with their electronic devices but may not be able to because they lack each other's contact information. In such a situation, people who wish to form a connection to interact further are forced to manually exchange contact information. The manual exchange may be tedious and time consuming and subject to mistakes. Consequently, it would be advantageous if there was a way for mobile device users to initiate and maintain communication with other mobile device users in close proximity without requesting the contact information of the proximally located user.

Some methods exist to allow mobile device users to digitally exchange information between their mobile devices without knowing each other's contact information but these methods suffer from various disadvantageous. One method of exchanging contact information between phones in a proximal location is called Bump. Bump requires both users to simultaneously jolt their mobile device. The Bump application senses the disturbance in the sensors of the mobile device and uploads the information to a server on the data network. The server then uses global positioning system (GPS) data and the time of the disturbance to determine which two proximally located phones were disturbed at the same time. Once the server has determined which two mobile devices were simultaneously disturbed, it routes the data between the two mobile devices.

Applications such as Bump suffer from serious disadvantageous. For example, Bump requires physical movement of the user to initiate a connection. In addition, Bump requires accurate GPS data to locate the mobile devices proximity. Many mobile devices may not be equipped with GPS capability or have it consistently enable. Even if the device has GPS capability, and has it enabled, the device may be in a location that does not get GPS signals. This is especially true when you consider that GPS signals have difficulty penetrating large cities or dense buildings. Accordingly, the Bump application may not work in many of the very situations where it may be most desirable to connect.

An additional disadvantage is that mobile devices may be jolted by accident at any time. These accidental disturbances that occur through normal use may cause Bump to incorrectly think that a user is trying to transfer data or form a connection.

Other methods of exchanging data with proximally located devices also exist but suffer from disadvantages of their own. For example, the Bluetooth protocol allows two proximally located devices to find each other and share data. However, Bluetooth devices need to be paired and pairing may be inconvenient and take too long to perform. Bluetooth also requires that devices be set to be discoverable and that they have appropriate software to recognize one another. Bluetooth connections also cannot persist once the devices are no longer proximally located.

To this end, there exists a need for methods and apparatuses to allow proximally located devices to conveniently communicate with each other, create and sustain a connection, and exchange information. The methods and apparatuses may allow communication between proximally located mobile devices that do not have any contact information about the other mobile device.

### SUMMARY OF THE INVENTION

In view of the foregoing, an object according to one aspect of the present patent document is to provide improved apparatuses and processes for initiating and maintaining connectivity between mobile devices. Preferably the apparatuses and processes address, or at least ameliorate, one or more of the problems described above. To this end, a method for initiating connectivity between mobile devices is provided. The method comprises the steps of: obtaining an invitation code at a first mobile device; transforming the invitation code into a sound wave signal designed to be transmitted by the first mobile device; and transmitting the sound wave signal from the first mobile device to a second mobile device.

In one embodiment, the invitation code is requested from a communication server. In another embodiment, the invitation code is an invitation to a group including at least one other mobile device. In some embodiments, the invitation code is only valid for a limited time.

In yet another embodiment, data is received from a mobile device in the group over a data network. In another embodiment, data is transmitted to a mobile device in the group over a data network. In some embodiments, the data is routed through a communication server. In various different embodiments, different kinds of data may be transmitted and received including data used to exchange payments of money. In one embodiment, the payment data is a percentage of a restaurant bill.

In yet another aspect of the present embodiments, a method of facilitating communication between at least two mobile devices is provided. The method comprises the steps of: receiving a join request from a first mobile device to join an additional mobile device to a group; creating an invitation code designed to be transformed into a sound wave signal; and sending the invitation code to the first mobile device.

In one embodiment, an add request is received from an additional mobile device to be added to the group. In certain embodiments, the add request includes the invitation code. The invitation code may be an invitation to the group, which includes at least the first mobile device.

In some embodiments, a plurality of add requests from a plurality of mobile devices may be received. The add requests may include the invitation code. In some embodiments, the additional mobile device may be added to the group.

In yet another embodiment, data is routed over a data network from the first mobile device to the additional mobile device. In various embodiments, the data may be different types of data including, in some embodiments, payment information. In one embodiment the payment information includes a percentage of a restaurant bill.

In another aspect of the present embodiments, a mobile device is provided. The mobile device comprises a processor; memory in communication with the processor; a speaker in communication with the processor; and a set of instructions residing in the memory and executable by the processor, wherein the set of instructions includes an instruction that causes the speaker to transmit a sound wave signal that includes an invitation code, inviting communication with another device.

In one embodiment of the mobile device, the set of instructions further comprises an instruction to request the invitation code from a communication server. In one embodiment, the invitation code is an invitation to a group including at least one other mobile device.

In yet another embodiment, the processor is programmed to receive data from or transmit data to a mobile device in the group over a data network. In one embodiment the data may information about a payment. The payment information may be related to various transactions including sharing a bill at a restaurant.

In another aspect of the present embodiments, a network computer is provided. The network computer comprises: a processor; memory in communication with the processor; a network connection in communication with the processor; and a set of instructions residing in the memory and executable by the processor wherein the set of instructions when executed by the processor, causes the processor to: create a group including the first mobile device; create an invitation code designed to be transformed into a sound wave signal; and transmit the invitation code to the first mobile device.

In one embodiment, the set of instructions further causes the processor to add another device to the group when an add request is received. In certain of those embodiments, the add request includes the invitation code. The invitation code may be an invitation to join a group.

In another embodiment, the set of instructions are further designed to route data over a data network from the first mobile device to the second mobile device. In various embodiments the data may be about payment information and that payment information may be related to sharing a restaurant bill.

The apparatuses and methods for communication between mobile devices described herein provide benefits over other methods and apparatuses. Further aspects, objects, desirable features, and advantages of the devices and methods disclosed herein will be better understood from the detailed description and drawings that follow in which various embodiments are illustrated by way of example. It is to be expressly understood, however, that the drawings are for the purpose of illustration only and are not intended as a definition of the limits of the claimed embodiments.

### BRIEF DESCRIPTION OF THE DRAWINGS

FIG. 1 illustrates one embodiment of a system for proximal communication between mobile devices.

FIG. 2 illustrates an audio spectrum analyzer image of one embodiment of a sound wave signal.

FIG. 3 illustrates a binary image of one embodiment of an invitation code.

FIG. 4 illustrates one embodiment of a system for communication between mobile devices.

FIG. 5 illustrates a database including a number of groups.

FIG. 6 illustrates a flowchart of steps performed by a device initiating a group using one embodiment of the methods of proximal communication between mobile devices of the present patent document.

FIG. 7 illustrates a flowchart of steps performed by the various devices and servers in one embodiment of the methods of proximal communication between mobile devices of the present patent document.

FIG. 8 illustrates one embodiment of an application initiation screen for an application that may be used to split a bill.

FIG. 9 illustrates one example of a bill detail screen for entry of bill information.

FIG. 10A illustrates one embodiment of a PIN entry screen.

FIG. 10B illustrates the PIN entry screen of FIG. 10A after automatically detecting a group.

FIG. 11 illustrates one embodiment of a payment screen for a payment application.

FIG. 12 illustrates one embodiment of a confirmation screen for a payment application.

FIG. 13 illustrates one embodiment of a mobile device for use with the methods and apparatuses of the present patent document.

FIG. 14 illustrates one embodiment of a communication server for use with the methods and apparatuses of the present patent document.

### DETAILED DESCRIPTION OF THE PREFERRED EMBODIMENTS

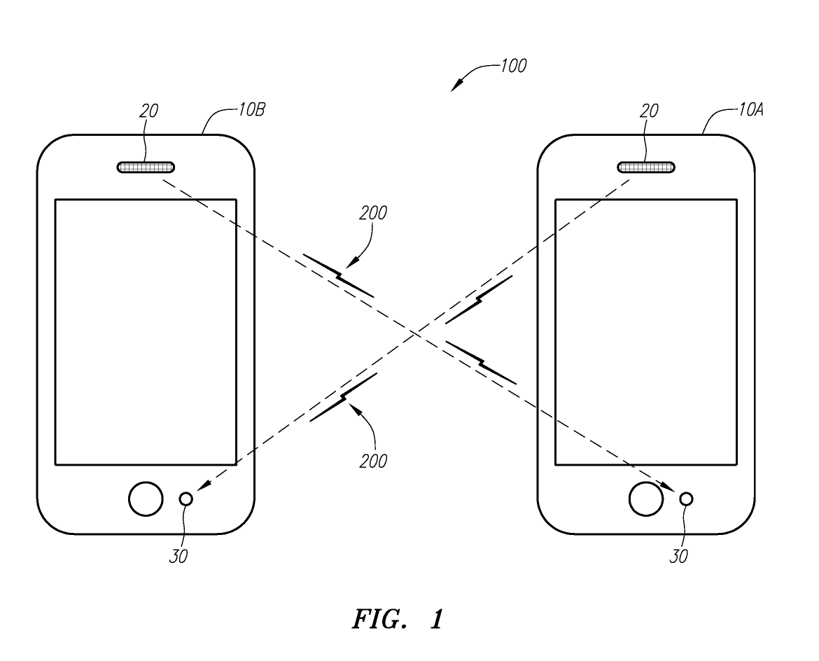

The present patent document describes methods and apparatuses for creating and maintaining a connection between mobile devices, which allows a user of one device to engage with a user or users of other devices. In particular, the present patent document describes methods and apparatuses for proximal communication between mobile devices (e.g., devices 10A, 10B of FIG. 1) 10 using sound wave signals 200 (FIG. 1). While a sound wave signal 200 may be generated for use on a unique occasion, users may continue the connection on an ongoing basis. A sound wave signal 200 is a sound wave with data encoded therein.

The present patent document describes a technology that allows devices, such as computers and mobile phones (e.g., iPhone®, Blackberry®, Droid®, Windows Phone 7, Nokia, etc.), to transmit digital data over sound waves. The sending device's speaker(s) (i.e. electro-acoustic transducers) generates sound waves and the recipient device's microphone(s) (i.e., acoustic-to-electric transducer) receives these sound waves. Digital data may be encoded into and decoded from these sound waves using the computer processor and software on the devices. The digital data transmitted over sound waves between the devices can be used to further initiate communication over another transport medium (which might be faster, more reliable, or simply better suited for the type of data being transferred), such as WiFi, 3G/4G cell phone networks, Bluetooth, Ethernet, or other media.

The methods and apparatuses may be used to establish a fast and simple handshake between two or more devices. The devices may continue to communicate using sound waves or may use the handshake to establish a connection over another data network. Due to the fact that speakers and microphones are present in all mobile phones and nearly all laptops and desktop computers, it is a technology that can be deployed onto existing devices.

Furthermore, most mobile phones and devices have programmable interfaces for writing software to send and receive sound waves. For example, Apple® provides a software development kit (SDK) for the iOS platform, which is the operating system for the iPhone®, iPod Touch®, and iPad®. Similarly, Android®, Blackberry®, Nokia®, Windows Phone®, and others mobile phone makers all provide SDKs for sending and receiving sound waves, in addition to the computer processing capability for encoding data to and decoding data from these sound waves.

FIG. 1 illustrates one embodiment of a system 100 for communication between proximal mobile devices 10A and 10B. In one embodiment, and as shown in FIG. 1, mobile device 10A and 10B (generally 10) may be a cell phone, such as an iPhone®, Blackberry®, or Android® phone to name a few. In other embodiments, mobile device 10 may be a mobile tablet such as an iPad® or a laptop computer or other portable electronic device such as an electronic organizer Generally speaking, mobile device 10 may be any electronic device capable of receiving data and/or communicating with another electronic device without being physically attached to a data network.

In the embodiment shown in FIG. 1, two mobile devices 10A and 10B are in communication with each other using sound wave signals 200. Although only two mobile devices 10 are shown (FIG. 1), other embodiments may include any number of mobile devices 10. In particular, a single mobile device 10 transmitting a sound wave signal 200 may be able to communicate with numerous mobile devices 10 simultaneously using a single broadcast of a sound wave signal 200.

Mobile devices 10A and 10B include a speaker 20 and a microphone 30. In the preferred embodiment, speaker 20 comprises an electroacoustic transducer that produces sound in response to an electrical audio signal input. However, the speaker 20 may be any device that allows the mobile device 10 to create sound. The speaker 20 may be able to produce sound at any frequency. The sound may be at a frequency audible to humans or inaudible to humans. Inaudible sound occurs at frequencies above (ultrasonic) or below those which can typically be heard by humans. Generally speaking, humans can hear sounds with a frequency between 20 Hz and 20,000 Hz depending on the individual.

The transmitting device may send data to a receiving device by digitally modulating the data with a carrier wave and emitting the resulting sound wave via the device's speaker. The receiving device listens for the signal at the pre-determined carrier wave frequency and performs the corresponding digital demodulation to decode the data. In the preferred embodiment, the carrier wave frequency is any frequency that is less than half the maximum sampling rate of the transmitting device or the receiving hardware (whichever sampling rate is smaller).

In the preferred embodiment, the speaker 20 may be a speaker already located on the mobile device 10 for purposes related to conventional use of the device. However in other embodiments, the speaker 20 may be a dedicated speaker on the mobile device 10 specifically designed for use with methods of communication using sound wave signals 200.

In the preferred embodiment, microphone 30 comprises an acoustic-to-electric transducer or sensor that converts sound into an electrical signal. However, the microphone 30 may be any device that allows the mobile device 10 to receive or detect sounds in proximity to the mobile device. The microphone 30 may be able to detect sound at a variety of frequencies. In the preferred embodiment, the microphone 30 may detect sounds that are both audible and inaudible to humans. However, in other embodiments, the microphone 30 may only be able to detect specific frequencies.

In the preferred embodiment, the microphone 30 may be a microphone already located on the mobile device 10 for purposes related to conventional use of the device. However, in other embodiments, the microphone 30 may be a dedicated microphone 30 on the mobile device 10 specifically for use with methods of communication using sound wave signals 200.

In the embodiment shown in FIG. 1, the mobile device 10A may communicate directly with the mobile device 10B without knowing anything about the mobile device 10B. For example, the mobile device 10A may not have any identifier data associated with mobile device 10B. Identifier data may include but is not limited to, the phone number, MAC address, IP address, the owner's name, a profile of the owner or some other information about the mobile device 10B to allow mobile device 10A to initiate or sustain communicate. Despite lacking any identifier information, the mobile device 10A may directly communicate with mobile device 10B using a sound wave signal 200.

In the embodiment shown in FIG. 1, in order to communicate with mobile device 10B, mobile device 10A produces a sound wave signal 200 with its speaker 20. The sound wave signal 200 produced by mobile device 10A has data encoded in the sound wave. As long as mobile device 10B is physically located close enough to mobile device 10A that mobile device 10B' s microphone 30 can detect the sound wave signal 200 emitted by mobile device 10A, mobile device 10B may decode and process the data that is encoded in the sound wave. This may be true even in the presence of background noise. Accordingly, mobile device 10A may communicate with mobile device 10B without having any identifier data associated with mobile device 10B.

Although in some embodiments mobile devices may initiate and sustain communication with other mobile devices 10 for which no identifier information is known, a lack of identifier information is not required to use sound wave signals 200. In some embodiments, the mobile device 10A may know something about the mobile device 10B including having identifier information about mobile device 10B but may still wish to communicate using sound wave signals 200.

Mobile device 10B may reply to mobile device 10A using the same process. Mobile device 10B may encode data to be transmitted to mobile device 10A in a sound wave and broadcast the sound wave signal 200 from the speaker 20 of mobile device 10B. Mobile device 10A may then receive the sound wave signal 200 at its microphone 30 and decode the data in the sound wave to determine the data sent from 10B. In this way, mobile device 10A and 10B may communicate back and forth.

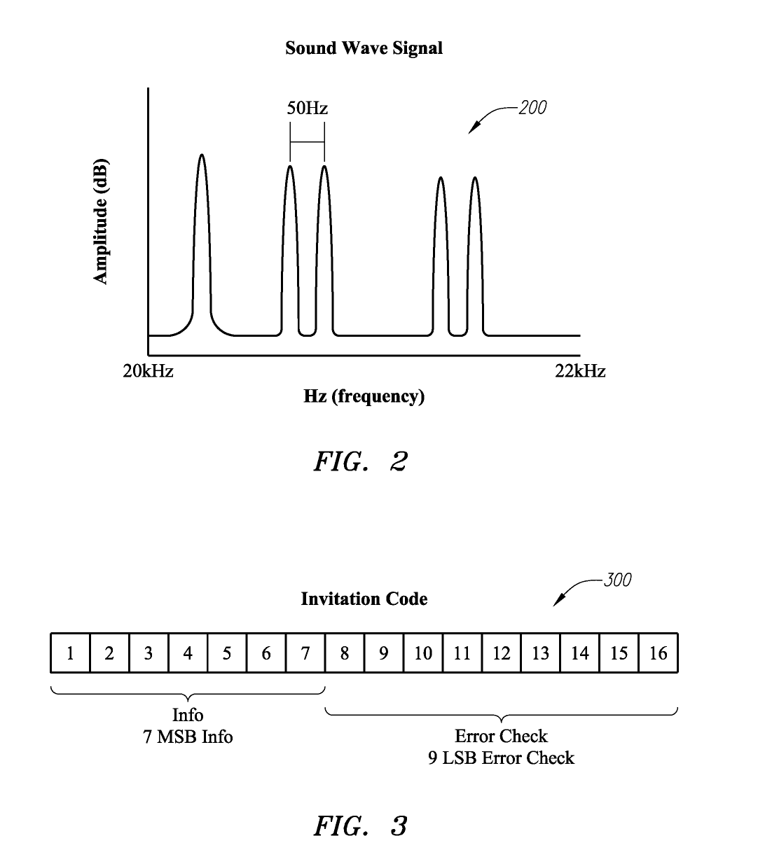

The data sent between the mobile devices 10A and 10B may be encoded in the sound wave in numerous different ways. FIG. 2 illustrates an audio spectrum analyzer image of one embodiment of a sound wave signal 200. In some embodiments, and as shown in FIG. 2, data intended to be sent via a sound wave may be broken into bits and sent as a static signal. A static signal is a sound wave signal that does not substantially vary over time. A static signal is a kind of sound wave signal bar code. In fact, a static sound wave signal looks similar to a bar code when viewed on a audio spectrum analyzer. Static sound wave signals are advantageous for their reliability but are hindered by a reduced bit rate as compared to streaming sound wave signals. An eight (8) bit sound wave signal would allow integers up to two-hundred and fifty-six (256) integer valves to be transferred. A sixteen (16) bit sound wave signal would allow integers up to sixty-five thousand five hundred and thirty-five (65,535) integer valves to be transferred. In other embodiments, more or fewer bits may be used for data transfer.

As shown in FIG. 2, and in the preferred embodiment, the individual bits are distributed at different bit frequencies along the audio spectrum of the static sound wave signal. If a tone is generated at a particular frequency, then the bit represented by that frequency is considered to be a one (1). If there is no tone at a particular frequency, then the bit represented by that frequency is zero (0). Depending on the embodiment and the number of bits used, different frequency bands and band widths may be used. The more bits used, the wider the frequency range needs to be. In the preferred embodiment, a range of approximately 20 kHz to 21.3 kHz may be used. As discussed above, the frequency range above 20 kHz is ultrasonic and will not be detectable by typical human hearing.

Another consideration in the width of the frequency band that may be used in various embodiments is the frequency spread between each bit frequency. The closer the bit frequencies are together, the narrower the total frequency band that may be used. However, the closer the bit frequency spread distance becomes, the harder it becomes to distinguish one bit frequency from another at the receiving mobile device, i.e. the signal to noise ratio is reduced. In a preferred embodiment, a bit frequency spread of about 50 Hz is used. However, in other embodiments other bit frequency spreads may be used.

In the preferred embodiments, some of the bits encoded in the sound wave are used for error detection. Error detection allows the receiving device to make sure that there are no errors in the detection of the sound wave signal or transformation of the sound wave signal into an invitation code. However, error detection is not used in every embodiment and in some embodiments, no error detection is performed. Various different methods of error detection may be used including: Reed-Solomon, turbo code, convolution code, a count of the zero bits or other error correcting codes known to those skilled in the art. In various embodiments, such codes may be applied in a single dimension or in multiple dimensions, may be combined, and may be combined with error detecting codes such as parity and cyclic redundancy checks (CRC/Checksum). Error correcting codes may be decoded and applied to correct transmission and/or reception errors at either the sending mobile device or the receiving mobile device.

FIG. 3 illustrates a binary image of one embodiment of an invitation code 300. An invitation code 300 is one example of data that may be sent using a sound wave signal 200. In the preferred invitation code 300, nine (9) bits of a total of sixteen (16) bits of data are used for error detection. Four (4) of the nine (9) bits used for error detection are used to count the number of zero (0) bits. The other five (5) bits are used for a CRC check. In other embodiments, a greater of lesser number of bits may be used for error correction.

In addition to error checks, amplitude thresholds may be incorporated at the bit frequencies to help distinguish signal from noise. Even if a tone occurs at a specific bit frequency, the bit at that frequency is not considered a one (1) unless the tone at that frequency exceeds a particular threshold in amplitude. The preferred embodiment uses amplitude thresholds to help prevent bit errors. However, in other embodiments, an amplitude threshold is not required.

In other embodiments, rather than having a static sound wave signal, the sound wave signal may be used to send a stream of data over a period of time. Data rates using streaming data may be much higher than with a static sound wave signal 200 and therefore, given the same time period, streaming data may be used to send larger amounts of data directly from one device to another. Streaming data using a sound wave signal may be done using frequency shift keying, phase shift keying, amplitude shift keying, multifrequency signaling or any other type of multiplexing of the data on the sound wave signal to facilitate streaming data. In embodiments that incorporate multiplexing data, the outgoing bit data is multiplexed (MUX) by the sending mobile device and demultiplexed (DEMUX) by the receiving mobile device.

In transmitting and receiving data using sound waves, often there will be other sounds present which will provide noise to the signals. To ensure proper decoding of the data in the presence of environmental noise, echoes and the limitations of the acoustic systems, in some embodiments, a sequence of transformations may be applied to each message to make the message intelligible when received by the receiving device. For instance, one such transformation may be the following process:

For each message that will be transmitted, a message header is attached describing the message type, length, and other relevant details. Then, the message is divided into fixed-length frames. A checksum (such as CRC-16) is completed on each frame data and appended to the frame. The entire frame is compressed using an algorithm such as gzip. Each frame is encoded using an error correcting protocol (channel code) such as Reed-Solomon. The resulting blocks are encoded using a line code or scrambling algorithm to improve the distribution of 1 s and 0 s in the bitstream. Prefix each encoded block with a special “syncword” (a binary string of a fixed length, say 32 bits) in order to facilitate proper byte and block alignment in the receiving device. Finally, the encoded data is digitally modulated with a carrier wave using a technique such as frequency shift keying (FSK), phase shift keying (PSK), amplitude shift keying (ASK) or any other digital modulation technique. After modulation, a digital filter may be applied to significantly reduce the transmitted message's frequency content outside of the signal band. The modulated and filtered message could then be converted to an analog signal by the device's digital-to-analog converter (DAC) as provided by its audio hardware API and used to electronically move a speaker to emit the signal.

When the acoustic signal reaches the receiving device's speaker, the receiving device's audio hardware's analog-to-digital converter (ADC) may sample the analog signal at uniform time intervals (the sampling rate) and then quantize the analog signal into a fixed length sequence of binary digits. The discrete samples may then be passed to the receiving application for processing where it may be decoded via an algorithm that inverts the Transmitter's encoding process. For instance, the samples may be filtered, demodulated, error detection and error correction performed, frame checksum verification and finally reassembled into the intended message.

Some of the parameters and algorithms that dictate how the message is encoded may be shared between the transmitting and receiving device. The information that the transmitting device and the receiving device must agree on in order to properly encode and decode a message is considered to be the Communication Protocol. Part or all of the Communication Protocol may be shared via diverse means, such as prior agreement when the software running on the transmitting and receiving device were designed. In other embodiments, the Communication Protocol may be agreed upon via any type of communications medium any time before or at the time of message transmission.

When data is transmitted using sound waves, the data may be corrupted on occasion due to many various factors. The various embodiments may deal with corrupted messages in many different ways. In one embodiment, the transmitting device may repeatedly broadcast the same message over and over again for a period of time, depending upon the application. The receiving device keeps listening until it successfully decodes the message.

In another embodiment, if the receiving device is unable to decode the message, it may use some other communications mechanism (possibly communication over a data network or even communication using sounds waves as just a couple examples) to tell the transmitting device that it should resend the message. Alternatively, in another embodiment, it may be decided that the transmitting device will always resend the message until it receives notification from the receiving device that the message has been received. The receiving device may communicate to the transmitting device that the message has been received or if there was some problem with the message (unable to decode the message) using any transport mechanism. In addition or independently, the transmitting device may set a timeout for the period of the broadcast to the receiver.

In the preferred embodiment, the transmitting device and the receiving device are designed for the characteristics of the acoustic medium. In embodiments that make use of already existing hardware on the device, typical speakers and microphones are designed for linear frequency response in the range from 20 Hz up to, roughly, 20 kHz. While the speakers and microphones may have been designed for such a range, they are still able to reproduce frequencies above 20 kHz, although the performance of the system may be degraded. If the frequency response rolls off above 20 kHz, as it will in nearly all acoustic systems, the receiving device's bandpass filter may be designed to compensate for this effect by amplifying the signal in the degraded frequency band.

A harder limit on the signal band is given by the sample rates supported by the audio hardware on each target platform. Nearly all platforms should support sampling at 44.1 kHz, thereby bandlimiting the channel to 0-22050 Hz. While other platforms may support higher sampling rates, the prevalence of the 44.1 kHz sample rate and the fact that audio hardware was designed to perform well in the human audible range, means the preferable embodiment is spectrally efficient at modulating the digital message to use the narrow band above human hearing and below the limitations imposed by the sampler and the audio hardware itself

Another issue specific to the choice of sound waves as the communication medium is signal attenuation. High frequency sounds, in particular, attenuate quickly as they travel through the air. Any modulation scheme that relies on accurately being able to measure the amplitude of a signal will be error prone due to the signal attenuation. For these reasons, the preferred embodiment of a system that multiplexes data uses PSK because it is spectrally efficient and is not sensitive to signal attenuation (unlike FSK and ASK respectively). However, other embodiments may use any form of modulation. As noted above, the choice of modulation may be dependant on the hardware limitations.

While there are many variations on PSK modulation, the preferred embodiment uses Quadrature Phase Shift Keying (QPSK) which modulates 2 bits per symbol. QPSK is a good balance between susceptibility to noise and spectral efficiency. Typically QPSK would be used to double the data rate over Binary Phase Shift Keying (BPSK). But in a bandlimited situation such as the acoustic channel, a better application of QPSK would be to reduce the symbol rate by half, thereby keeping the effective data rate equal to the data rate afforded by BPSK while cutting the modulated signal's bandwidth in half, thus using the acoustic channel's frequency spectrum more effectively. The downside is that QPSK has increased bit error over BPSK, but that can be compensated for by the choice of the channel code and its parameters.

The various embodiments described herein may be used to transfer any type of information between devices. For example, upon handshake, the devices could exchange information about device capabilities. For example, mobile device 10A could transmit information to mobile device 10B that it is has a camera, has Bluetooth enabled, and is connected to the Internet. This exchange of capabilities could be used to determine the best way of further communication and interaction.

In other embodiments, two devices could share information, such as address book contacts, documents, images, or other files by transmitting this data over sound waves. In another embodiment, two devices could send messages back and forth, such as in instant messaging. In yet another embodiment, two devices could send data back and forth for use in video games.

When two devices send information back and forth using sound waves it may be received by any device that can detect the sound waves. To this end, certain embodiments may encrypt the data. In one embodiment, information may be transmitted securely between two devices using asymmetric encryption, such as RSA public-key cryptography. The devices exchange public keys to ensure that the data sent back and forth is not understood by another device. Encryption is particularly beneficial in the transmission of sensitive information, such as payments or credentials.

If mobile device 10A and mobile device 10B wish to securely exchange data, one device (10A) could share a cryptographic public key with the other device (10B). From there, mobile device 10B could create a symmetric key (such as AES), encrypt it using mobile device 10A's public key, and transmit it to mobile device 10A using a sound wave signal 200 (or NFC, Bluetooth, or similar transport). Using the symmetric key, the devices can encrypt data sent back and forth.

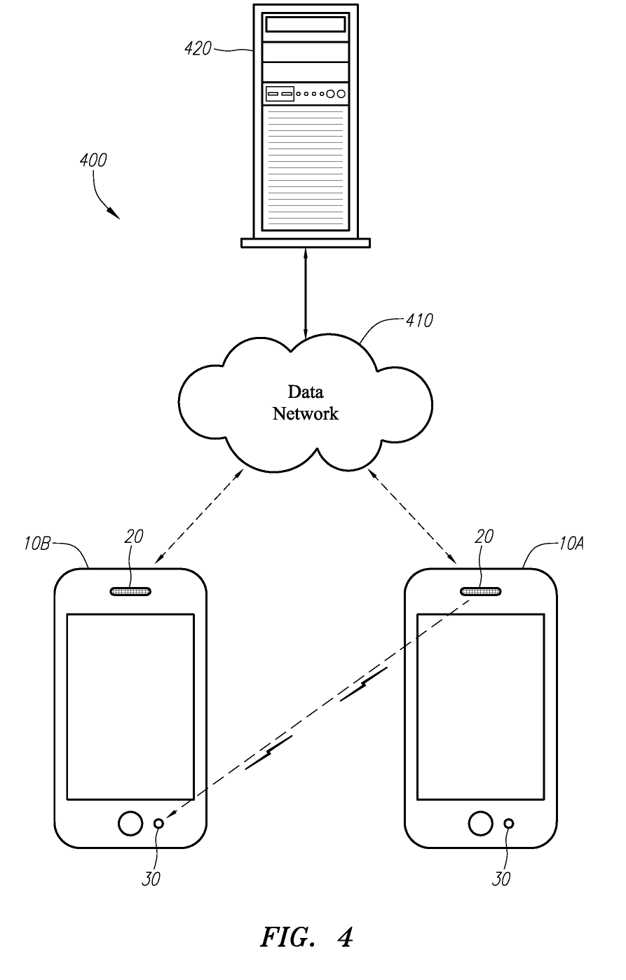

FIG. 4 illustrates an embodiment of a system 400 for communication between mobile devices 10. In the embodiment of system 400 shown in FIG. 4, data encoded in a sound wave signal 200 may be transmitted between mobile device 10A and mobile device 10B to initiate communication. After communication is initiated, data may be further transferred between mobile device 10A and 10B via a data network 410. In the preferred embodiment, a data transfer between mobile device 10A and 10B is initiated using a sound wave signal transmission before data transfer over the data network 410 persists. However in other embodiments, data may be transferred after initiation using sound wave signals 200 or using the data network 410 or using some combination of both sound wave signals 200 and the data network 410.

Allowing mobile devices to communicate over a data network 410 after initiation using sound wave signaling 200 is advantageous because the mobile devices do not need to be proximal to each other to communicate over a data network 410 such as the Internet. This allows the mobile devices 10 to get the benefits of connecting via sound wave signaling 200 as taught herein and also the benefits associated with communication over a data network 410 such as long range and high data rate transfers.

In various embodiments, data network 410 may be any type of data network including wired and wireless. Examples of data network 410 include the Internet, a wide area network (WAN), a local area network (LAN), a point to point connection, a local connection between two devices or any other type of data network 410. The connection may be established using any wireless data network technology including but not limited to IEEE 802.11 (WiFi), WiMax, Bluetooth, or a cellular network technology. Cellular networks may be based on CDMA, TDMA or GSM and include 3G, 4G and Edge networks to name a few.

In embodiments that transfer data over a data network 410, such data transfer may be facilitated using any data transfer protocol. For example, data may be transferred using file transfer protocol (FTP), HTTP, TCP/UDP sockets, custom protocols, or any other type of protocol capable of transferring data.

In embodiments that communicate over a data network 410, communications sent between the client and the server may be encrypted or not. In the preferred embodiment, the communications over the data network 410 are encrypted. In embodiments that encrypt data, the data encryption may be done using secure sockets layer (SSL), Advanced Encryption Standard (AES) or any other type of data encryption. For example, a custom encryption may be used consisting of RSA and shared AES keys over TCP sockets. In other embodiments, other types of encryption may be used.

As just one example, if two devices wish to securely exchange data, and they both have a connection to a data network 410 such as an Internet connection, one device, (mobile device 10A) could share a cryptographic public key with the other device (mobile device 10B) by sending it over the Internet through a server. From there, the devices would securely send data using sound wave signals 200 or via the data network 410.

In certain embodiments, only one device may be able to connect to a data network 410 but both devices wish to communicate securely. In such an embodiment, a server could be used to assist in the exchange of cryptographic keys. This might be useful in the instance that the data transfer rate is not fast enough for a desired application, such as transferring a large public key or the encrypted data from that public key. For example, if the device lacking a network connection has some type of account with the server, keys could be securely created in the following manner: 1. Mobile device 10A, which in this example does not have an Internet connection, could transmit a user account ID to mobile device 10B using sound wave signals. This data would be sent without encryption. 2. Mobile device 10B would securely connect to the server (over SSL/TLS or other secure transport). 3. Mobile device 10B would submit the user account ID from mobile device 10A along with a unique key created by mobile device 10B. 4. The server would look up a cryptographic key for mobile device 10A using the user account ID. The server would use this cryptographic key to hash or encrypt the unique key provided by mobile device 10B. This could be a hashing algorithm such as HMAC. The server would then send this encrypted or hashed data back to mobile device 10B over a secure channel (such as SSL/TLS). 5. Mobile device 10B would send the unique key, generated in step #3 to mobile device 10A using sound wave signals. As mobile device 10A also has the same cryptographic key as on the server, it can generate the encrypted or hashed data as in step #4 using the same algorithm. This step could occur concurrently with step #3 or #4. 6. This encrypted or hashed data can be used as a symmetric key, such as AES, to securely send data back and forth between devices.

The above method of establishing a secure connection when only one device has a data network connection may be used by the devices to allow the device with the network connection to access data located on a server. Once a secure connection is established between the devices, for example using the method explained above, mobile device 10A may send a unique ID associate with the data on the server to mobile device 10B in encrypted form using the symmetric key. Mobile device 10B may then submit this unique ID to the server over a secure channel to retrieve the data or asset.

Using cryptographic keys, as described above, may be one way of ensuring the data sent between two devices is secured from tampering. The use of cryptographic keys often involves using a combination of private/public cryptographic key pairs (and sometimes symmetric cryptographic keys in addition) to prevent other parties from viewing the data. To prevent relay attack (as well as man-in-the-middle and replay attacks), the devices may use message IDs and cryptographic signing of the data in addition to sending the data through a trusted server. These techniques work well when the sending and receiving devices are verified. When a computer connects to a secure website over the internet, the SSL certificate may be verified through a trust chain to a root authority. With this invention (as well as NFC and Bluetooth), it is difficult to guarantee that two devices in proximity of each other are actually communicating with one another. It is possible for a third party device to intercept the messages and impersonate one or both of the devices.

In some embodiments, a network server could be used to securely provide additional information to the user for verification. For example, if a person was using their mobile phone to make a payment with a retail terminal, the screen on the device could show a code that would also be shown on the mobile phone. If the devices then connect to a trusted server, it can most likely be trusted that there is no man-in-the-middle unless the trust authority on both devices has been compromised. In a similar manner, two people wishing to exchange data with each other can have the same code, image, or other data shown on both screens. By looking at each others' screens they can reasonably be sure that their devices are communicating with each other and not a malicious third party. By incorporating a trusted server for sending data back and forth, the server may provide verification details to both parties.

In some embodiments, users may create accounts with a service and link credentials to this account, such as their Facebook identity, address, picture, phone number, email address, or other information. Such information could be transferred to the other party when connecting to provide additional verification about the device they are communicating with.

In certain embodiments, both devices may communicate through a trusted server to verify that two devices are communicating with each other securely and without man-in-the-middle, replay, or other malicious attacks. This server may be used for only verification or for all data transfer after the initial device handshake. In some embodiments, the cryptographic public/private key pairs may be issued and signed by the server to provide an additional layer of device identity verification. In embodiments that are secure, users may store data, such as their credit card information, on the server instead of the device, or in addition to the device.

In some embodiments, trust mechanisms may also be used. For example, two users (User1 and User2) exchange data between their mobile phones using one of the embodiments disclosed herein and then one of the users (User1 for example) exchanges data with a third user (User3). This information may be sent to a server that records these connections. In the future, if User2 chooses to exchange data with User3, the server can provide information to each party that they both have a common device that they have trusted. Trust information may be valuable when exchanging data, such as URLs, which could open up a malicious website on the user's device. In addition, if it is discovered that one device has been compromised (potentially with a computer virus) or is malicious, users who have exchanged data with that device may be notified of this problem and the level of trustworthiness of the device may be adjusted. In other embodiments, additional mechanisms, such as cryptographic keys provided by a trusted party may be additionally used to provide an additional levels of trust.

In embodiments that use a data network 410, a communication server 420 may help facilitate communication between the mobile devices 10. In some embodiments, the communication server 420 may be involved in the initiation of communication between mobile device 10A and 10B. In some embodiments, the communication server 420 may further be involved in the subsequent communication between mobile device 10A and 10B after initiation. In other embodiments, the communication server 420 may be involved in initiation of communication only.

In one embodiment where the communication server 420 facilitates or is involved in the subsequent communication between mobile device 10A and 10B, communication between mobile device 10A and 10B over the data network 410 is routed through a communication server 420. In other embodiments, a communication server 420 may only be involved in the initiation of communication between the mobile devices and then the mobile devices may communicate directly with each other over one or more data networks 410 for subsequent communications. In yet other embodiments, the communication server may route some data between the mobile devices 10 over one or more data networks 410 while other information is sent directly between the mobile devices 10 over one or more data networks 410.

An example of an embodiment that uses a server to facilitate data exchange will now be explained in more detail. Such an embodiment may be implemented using one or more server components. For example, a mobile device 10A may send a photo to mobile device 10B as follows:

Mobile device 10A may establish a network socket connection with a message server. Mobile device 10A may transmit information to the message server requesting a connection for sending a file, potentially including information about the file, such as the size in bytes. The message server could respond to mobile device 10A with URLs of the data pipe server for which the sender and receiver should connect. Mobile device 10A may then establish a network socket connection to the URL of the data pipe server provided by the message server (this service might be running on the same physical machine or another). Mobile device 10A may then (or concurrently) transmit a message using sound waves to mobile device 10B with information about the file it wishes to transfer, including the URL of the data pipe server provided by the message server. Mobile device 10B may then make a network socket connection to the URL of the data pipe server. When both devices have made a connection to their respective URLs, mobile device 10A may transfer the file to that data pipe server, which would send the data to mobile device 10B.

In various embodiments, the message server may be used for authentication, limiting transfer by user account or IP, auditing, or other type of control. Upon receiving the request from mobile device 10A, the message server may notify the data pipe server about the upcoming transfer and include information about the file size. The file size information may be used to determine if the actual transfer was successful, as well as to cancel transfers that are larger than anticipated (such as to prevent abuse of the service). Although various embodiments may use a single server or a plurality of servers, having two servers separates the concerns of file transfer from various others, such as user account management.

The embodiments disclosed herein may be used in various ways. For example, two devices may transmit files to each other. For example, a laptop could send pictures to a mobile phone. To do this, the laptop could establish an Internet connection with a server and then transmit the connection URL to the mobile phone using sound waves. The mobile phone could then connect to the server using the connection URL and the laptop would then send the data to the server, which would then send the data to the mobile phone. The server component could operate similar to services such as Drop.io3 and Awesome Drop4. In other embodiments, two devices could also directly connect over a local WiFi network using this invention to share the local IP address.

In yet another embodiment, a device could transmit location data to another device using sound waves. For example, a speaker at a shopping mall could transmit location information to another device providing details of the location within the mall. This could be in the form of relative coordinates within the mall, latitude and longitude, or other form of location information. As GPS is often not available inside a building, such as a shopping mall, this could be a way of passing that information to a user's device. In addition, additional data, such as a local map, could be transmitted as digital data over sound waves to the device, so that the user could know the layout of the facility they are in. This location and map information could be helpful in shopping areas, parks, stadiums, museums, airports, and other large facilities.

Other embodiments may be used to provide WiFi authentication credentials. Coffee shops commonly provide free wireless Internet to their customers. To prevent non-customers from using the wireless Internet, they often require a password to access the wireless access point. This password is sometimes written on a wall in the coffee shop or a customer must ask an employee for the password. To simplify this process, the password credential could be transmitted over sound waves within the coffee shop. Customers inside the coffee shop could then connect to the wireless access point without having to ask the employee or look for the password on the wall. Only those people who have devices in range of the sound wave broadcast would learn the wireless password.

A similar embodiment may be used in other locations, where there is a need to provide access to secured wireless network (i.e. one that is not Open WiFi) only to users who are at the location and not to those outside the location, but close enough to receive the wireless signal.

Still yet other embodiments may be used for other connections, such as a Virtual Private Network, where the credentials should only be known by those in that location. Still other embodiments may be used to configured and initiate other transport mediums, such Bluetooth and Ultra-wideband just to name a few.

In some embodiments, sound wave signals 200 may be used to transmit information to mobile users in a specific location. For example, at a venue, such as a sports stadium, speakers could broadcast information, such as the current score, food and drink deals, advertisements, coupons, details of the last play (e.g. football quarterback threw an 8 yard pass for a first down; baseball batter hit a double), game sponsor information, event calendar, or anything else of interest to the fans.

In another embodiment, a location may provide information in other languages to users. This may be helpful in locations where the signs, maps, or verbal audio is in a language that is foreign to a user.

In yet another embodiment, the sounds wave signals may be used at a shopping location, such as a clothing store. In such an embodiment, speakers could broadcast information, such as what items are currently on sale or other store discounts. At a museum, speakers could provide additional information on paintings, sculptures, or other exhibits.

In still another embodiment, emergency information could be broadcast to devices in this manner. In addition to the verbal announcements, information on evacuation and safety could be sent to users' devices over sound waves. This could be valuable in situations where Internet and mobile networks are disabled due to natural disaster or terrorist attack. This vital information could be broadcast far distances over emergency speakers to users' devices.

In yet another embodiment, the embodiments described herein may be used for point of sale (POS). POS software may run on common operating systems, such as Windows, Linux, and Mac OSX, or even tablet computers, such as the iPad, HP WebOS tablets, or Android tablets. In some embodiments, the methods and appratuses described here may be integrated to already existing POS systems. For example, a company called Square provides a device that attaches to the headphone jack of iOS and Android devices to allow merchants to swipe credit cards. Embodiments taught herein may be integrated into that type of POS or other POS packages to allow the merchant to accept mobile payments, coupons, gift cards, and loyalty cards. In other embodiments, the entire POS transaction may be accomplished using the methods and apparatuses described herein. These POS systems could also integrate with Verification and Trust services as discussed earlier. As numerous embodiments are primarily software based, they may potentially be integrated more quickly into other software packages, such as POS.

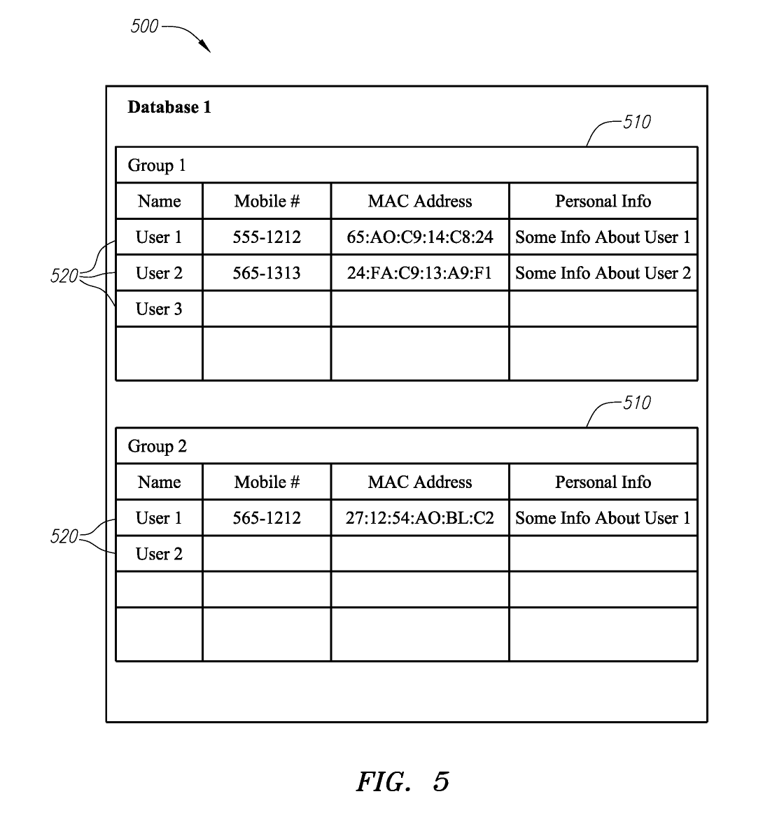

In certain embodiments, communication server 420 may provide a number of other communication functions between mobile devices 10. For example, communication server 420 may include a database 500 or a number of databases 500 that include a group 510 or groups 510. FIG. 5 illustrates a database 500 including a number of groups 510. A group 510 is any association of data about or submitted by people, users, users of mobile devices or any other association of data. Each group may have one or more members 520. In the preferred embodiment, each member 520 is associated with a record of the data associated with a particular mobile device 10. However, in other embodiments, members 520 of the group 510 may or may not have mobile devices 10. The communication server 420 may allow members 520 to join or leave a group 510. The communication server 420 may facilitate the exchange of information between members 520 of a group 510 to allow those members 520 to share data via their mobile devices 10. Accordingly, two users of mobile devices 10 that may not have even known each others names or any identifier information about each other may connect via a sound wave signal 200 and then share information with the applicable group via the communication server 420.

In the preferred embodiment, the database 500 may reside on a communication server 420 or other server connected to the data network 410. However, in other embodiments, the database 500 may reside locally on the mobile device 10. In one embodiment, a dedicated database server is used to store and handle the database 500. More than one database 500 or database server may also be used. The database 500 may contain information about any number of groups 520.

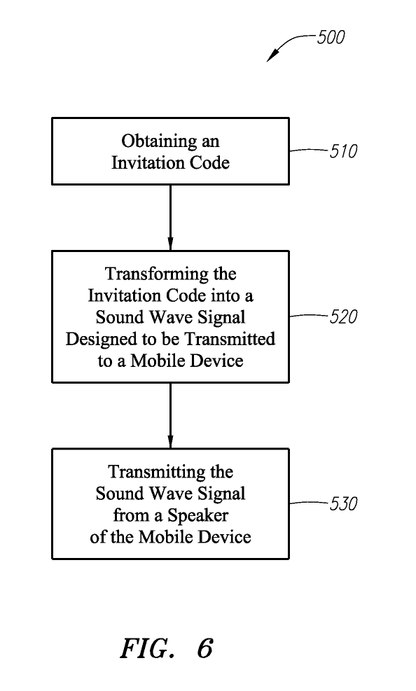

FIG. 6 illustrates a flowchart of steps performed by a device initiating a group 510 using one embodiment 600 of the methods of proximal communication between mobile devices 10 of the present patent document. The method 600 embodied in FIG. 6 is begun by the step 610 in which a mobile device 10 obtains an invitation code 300. An invitation code 300 may be any unique identifier and is used as an invitation to begin communication with another device and/or its user, including user interfaces other than a mobile device 10. As discussed above, in some embodiments the invitation code 300 may be an eight (8) bit or sixteen (16) bit code and may or may not include error detection. In other embodiments, longer or shorter invitation codes may be used. In the preferred embodiment the invitation code is a sixteen (16) bit unique code.

In some embodiments, the invitation code 300 may be generated on the mobile device 10. However in other embodiments, the invitation code 300 may be generated by another device, such as a database server, other mobile device, or computer processor. For example in the preferred embodiment, a mobile device 10 that wishes to communicate with another mobile device 10, sends a join request to request an invitation code 300 from the communication server 420 via the data network 410. A join request is any request by a device to obtain a invitation code 300 that may be used to add additional members 520 to a group 510. Once the communication server 420 receives a valid join request, the communication server 420 generates the invitation code 300 and sends it to the mobile device 10.

In some embodiments, the join request may contain information about which group 510 an invitation code 300 is being requested for. In certain embodiments, other information may also be included in the join request such as information about the requester or information about some transaction the group may facilitate. The group 510 may be an already existing group 510 with a number of members 520 already associated with it. In other embodiments, the group 510 may be a new group 510. If the join request is for a new group 510 the requester may be automatically added and an invitation code 300 returned for the new group 510.

Similar to join requests, in the preferred embodiment the invitation code 300 includes information that associates the invitation code 300 with a group 510. In some embodiments, the invitation code 300 may include additional information about the mobile device 10 that requested the invitation code 300, the group 510, the purpose of the group 510, or any other relevant data.

In the embodiment shown in FIG. 6, after the invitation code 300 is obtained in step 610, the invitation code 300 may then be transformed into a sound wave signal 200 designed to be transmitted to a mobile device 10 as shown in step 620. In some embodiments, the invitation code 300 may be transformed into a sound wave signal 200 on the mobile device 10. In other embodiments, the invitation code 300 may be transformed into a sound wave 200 signal prior to being sent to the mobile device 10 that requested the invitation code 300. For example, the invitation code 300 may be transformed into a sound wave signal 200 on the communication server 420 and then transferred to the mobile device 10. In embodiments where the sound wave signal 200 is generated by a means other than the mobile device 10 itself, the sound wave signal 200 may be transferred to the mobile device 10 in the form of a .wav file, mp3 file or other audio file format, including formats which become commonly used to transfer audio files in the future.

Once the invitation code 300 is transformed into a sound wave signal 200 in step 620, the mobile device 10 may transmit the sound wave signal 200 from a speaker 20 of the mobile device 10 as shown in step 630. Other mobile devices 10 desirous of joining a group will be “listening” for a sound wave signal 200 at the appropriate frequency band. Listening in this context means periodically sampling at a frequency band to determine if a sound wave signal 200 is being transmitted.

Once a mobile device 10 detects a sound wave signal 200, the mobile device 10 may receive the sound wave signal. In embodiments that include an invitation code 300, the mobile device receiving the sound wave signal 200 may demodulate it to determine the invitation code 300. Once the invitation code is determined the receiving device may use it to join a group.

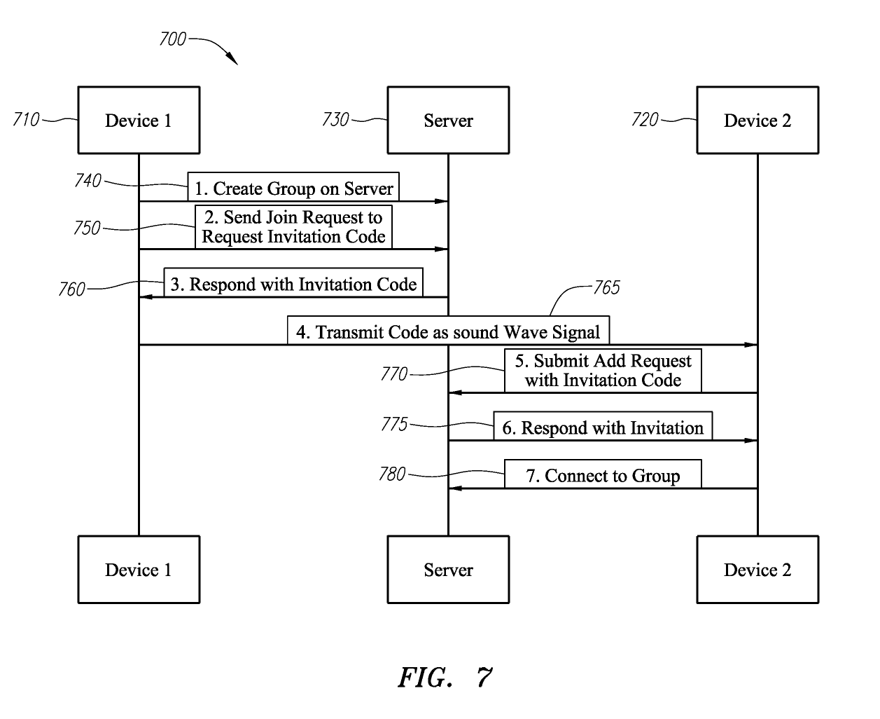

FIG. 7 illustrates a flowchart of steps performed by the various devices and servers in one embodiment of the methods of proximal communication between mobile devices of the present patent document. FIG. 7 includes the steps performed by the device 710 initiating the communication and transmitting the sound wave signal 765 as well as the device 720 receiving the sound wave signal and joining the group 780. The embodiment shown in FIG. 7 also includes the steps performed by the communication server 730.

As shown in the embodiment in FIG. 7, a device 710 may first create a group on the communication server 730 as a separate step. However, in other embodiments the group may be created automatically by the communication server 730 when the device 710 sends the join request 750. As explained above, once the group is created 740 and the join request is sent to retrieve an invitation code 750, the server will respond with an invitation code 760 and the device may transform the invitation code into a sound wave signal and transmit the sound wave signal 765.

In embodiments that use an invitation code, once the sound wave signal is received by another mobile device 720, the invitation code may be decoded from the sound wave signal and an add request may be sent 770. An add request is a request to add the sender to the group associated with the received invitation code. In the preferred embodiment, the add request is sent by the receiving device 720 across the data network to a communication server 730 in step 770. The communication server 730 may then process the add request and add the sender of the add request to the group.

In some embodiments, the communication server 730 may add the device 720 to the group immediately upon receiving the add request. In other embodiments, such as the one shown in FIG. 7, extra steps may be used. As shown in FIG. 7, an additional handshake may be required between the communication server 730 and the device 720 in order to be added to the group. In the embodiment of FIG. 7, upon receiving an add request, the communication server 730 responds to the device that sent the add request with an invitation 775 to join the group. In some embodiments this invitation may include additional information about the group the device 720 is about to join. Once the device 720 receives the invitation it may then respond to the communication server 730 requesting to be added to the group 780.

If there is more than one device in close proximity to a device transmitting an invitation code 300 via a sound wave signal 200, more than one device may receive the sound wave signal 200. [In various embodiments, the device could be another mobile device 10 or a device that is not considered mobile such as a base station, router, computer or other wired device.] Accordingly, a single invitation code 300 may be broadcast (multicast) and received or detected by the microphone 30 of any number of receiving devices. In embodiments that incorporate an invitation code 300, each receiving device may receive the sound wave signal 200, decode the invitation code 300, and send a add request to join the group associated with the invitation code. Accordingly, multiple devices may be added to a group 510 with a single invitation code 300.

Although the sound wave signal 200 may be detected by multiple devices, and in particular multiple mobile devices 10, the sound wave signal 200 may have information encoded in it to restrict the message to a single device. For example, the sound wave signal 200 might be encoded in a manner that allows only a specific device to decode the sound wave signal 200. In another embodiment, the invitation code 300 may be restricted to a single device by the communication server 420 so that although multiple devices may receive the sound wave signal 200 and send an add request in response to the invitation code 300, the communication server 420 only adds one or more selected, specific receiving devices to the group 510.

In some embodiments, the invitation code 300 may only be valid for a limited time. By limiting the time an invitation code 300 is valid, specific numbers indicating a unique invitation codes 300 may be reused. The ability to reuse invitation code 300 numbers reduces the number of bits needed in the invitation code 300. The expiration time period of the invitation code 300 may be controlled on the device that requests the invitation code 300 or the device that administers the invitation code 300. For example, the communication server 420 may track and limit the time period that an invitation 300 code may be accepted. In some embodiments the invitation code 300 may expire in a few minutes. In other embodiments, the invitation code 300 may take hours to expire or even longer. In yet other embodiments, the invitation code 300 may never expire. Combinations of invitation codes 300 that expire and invitation codes 300 that do not expire may also both be used.

In still other embodiments, the invitation codes 300 may be constrained by Global Positioning System (GPS) data or other similar electronic location data. Limiting the invitation code 300 to a geographical location with GPS data ensures that both devices are in proximity to each other. Proximity data reduces the potential for a false positive, a device hears the wrong code and accidently joins a group located somewhere else. Proximity data also increases the number of instances in which a particular invitation code can be used, since users on the East Coast, for example, would be unlikely to come into proximity with users on the West Coast within a limited time period of one hour. In certain embodiments, the invitation codes may be limited by both time and GPS data.

In some embodiments, additional mobile devices 10 may be joined to a group 510 including at least the first mobile device 10 very quickly. Although in most embodiments there is no time limit as to how fast two mobile devices 10 need to be joined to the same group 510, a user may appreciate a very short timeframe in which a new user can join a group. In the preferred embodiment, a second mobile device 10 may be added to a group in about 100-200 ms.

Once the connection between the two mobile devices 10 has been established, for example the two mobile devices 10 are joined in the same group 510, the mobile devices 10 may begin sending data back and forth. In the preferred embodiment, the mobile devices 10 send data back and forth across the data network 410 or a plurality of data networks 410 both to other devices in the group and to a location on a database server where information about their group is stored. The data may include text, media, links to online profiles, contact information, request or transfer of payment information, information about a shared shopping cart, or any other type of data two users may want to share.

In some embodiments, the method of initiating communication between two mobile devices 10 using sound wave signals 200 may be substantially passive. For example, for those mobile devices joining the group 510, the process may be substantially passive. In some embodiments, the device joining the group 510 only needs to have the software program that is listening for a sound wave signal 200 running to join the group. The software program may be running in the background on the mobile device 10. The software program would be listening on the appropriate frequency band for any sound wave signals 200 being transmitted in close proximity. Once a sound wave signal 200 was detected, the mobile device 10 may transform the sound wave signal 200 into an invitation code 300 and then send the invitation code 300 to the communication server to join the group.

In other embodiments, joining a group may require the user of the mobile device 10 to confirm that they want to join the group 510 for which they have received an invitation code 300. The confirmation may be in the form of a pop-up message requesting them to confirm or deny joining the group. In other embodiments, the confirmation may be more elaborate such as visiting a website and entering data about the mobile device 10 and/or the user of the mobile device 10.

In embodiments requiring information from a potential member trying to join a group 510, any amount of information may be requested. Examples of the types of information that may be requested or required from a potential member to join a group 510 include: the mobile device number; user name; user personal information; user demographic information; user preferences or any other type of information. All this information may be stored in a database 500 on the data network 410 and may be part of a member's 520 profile. In different embodiments, the information may be requested from a potential member in various different ways. For example, the potential member may be requested to enter the information on a website. The potential member may connect to the website via hyperlink or other method. In other embodiments, the information request may be part of a custom pop up window displayed on a mobile device 10 that the user is required to fill out. In yet other embodiments, the information may be requested from the potential member using other methods.

Once two or more people, or two or more mobile devices 10, are members of a group 510, data may be shared among the members 520 of the group 510. Data may be shared through the data network 410, or directly between mobile devices 10 using sound wave signaling 200. In the preferred embodiment, an application local to the mobile device 10 helps facilitate the sharing of data between members of the group 510. For example, the application running locally on the mobile device 10 may include a graphical user interface (GUI) that allows users to interface with other members 520 of the group 510 or data associated with the group 510. The GUI may be used in combination with any type of interface including track balls, a mouse, touch sensitive screens, key pads, and other interface types. In some embodiments, the GUI may be run in combination with touch sensitive screen allowing the mobile device user to touch the screen to retrieve more information from the group 510. As just one example, the GUI may display a scrollable list of all the members 520 of the group 510 and a mobile device user who is a member 520 of the group 510 may be able to touch any member 520 in the list to retrieve more information about that group member 520. Any such data may also be transmitted to and stored on a server, where it can be accessed by other group members.

Various kinds of data may be shared between members 520 of a group 510. For example, members 520 of a group 510 may have profiles that other members 520 may see. Member profiles may include names, email addresses, addresses, pictures, comments, links, history or other personal data. In certain embodiments, members may link other profiles to their group profile including their Facebook®, Twitter®, Foursquare®, Myspace®, LinkedIn® , Google®, and other social network profiles. In other embodiments, the group member profiles may, but need not, be similarly linked to a member's 520 external social network profiles.

In one embodiment, members 520 of a group 510 may be shown things they have in common with other members 520 of the group 510. For example, members 520 of a group 510 may be shown other members 520 of the group 510 they are friends with on Facebook®, connected to on LinkedIn® or associated with on another social media website.

In another embodiment, pictures may be shown from Facebook® or another website that include both members of the group. In yet another embodiment, common interests of group members 520 may be displayed. For example, members 520 may be notified if other members 520 went to the same school, like the same movie, like the same music, lived in the same place, travelled to the same country, were born at a similar time, or have any other common interest or commonalities between them.

In some embodiments, mobile devices 10 and/or their users may be members 520 of more than one group 510. In embodiments where users may be members 520 of more than one group 510, members 520 may be shown other members 520 of one group who have also joined one or more additional groups 510.

In one embodiment, members 520 of a group 510 may also be able to customize their own group profiles. For example, members 520 may be able to upload pictures, documents, links or other media. In some embodiments, members 520 of a group 510 may also be able to comment on the media they have uploaded or the media others have uploaded or just make general status comments on their profile. Such information would be visible to other group members.

In some embodiments, members 520 of a group 510 may also be able to link to other personal information on the Internet. For example, users may be able to add links to their profiles or accounts on Flickr, Dropbox, Box.net, Picassa or any other digital asset available for sharing.

In certain embodiments, members 520 of a group 510 may be able to link payment data or banking information to their group profile to allow members 520 of the group 510 to exchanged money or payments between them. Electronic money or electronic currencies may also be exchanged using these methods. As one example of a monetary exchange, members 520 may have interfaces with their PayPal® accounts such that members 520 of the group 510 may be able to exchange funds via PayPal®. Interfaces with a member's PayPal® account may be in the form of a hyperlink or may simply be a reference to the member's email address associated with PayPal®. The interface may require a log-in with a third party.

Advantages exist to using the methods and apparatuses described in the present patent document to exchange payment information. For example, to reduce theft of a customer's credentials and identity information (e.g. credit card number, address, phone number, date of birth, mother's maiden name, etc.), a third party server could provide verification and authorization of the transaction without requiring exchange of the customer's information. When paying a bill at a restaurant, a customer will often provide a credit card to the waiter. The waiter will then take that credit card to the register to swipe the card for payment. During that time, the waiter could write down the customer's credit card information. In addition, some merchants ask for the customer's driver's license. When providing this additional verification, the customer is potentially at a higher risk for that identity information to be stolen. By using a third party payment and verification service, the parties could make a transaction without exchanging sensitive information. This may reduce fraud and identity theft. Credit card processing services could employ this type of mechanism to protect customers. The merchant would potentially not need to know anything about the customer (i.e. identity, name, credit card number). The merchant could trust the payment and verification service that the transaction would go through.

To protect the customer, the payment and verification service could provide a challenge mechanisms to the customer's device asking him or her security questions that are often used on website's during login (e.g. mother's maiden name, first card, name of first pet, etc.). These questions could also be similar to those asked by services such as Transunion, Experian, and Equifax to verify identity.

In other embodiments, members 520 of a group 510 may share game data or data related to a game or game play. For example, members 520 of a group 510 may compete against each other or compete cooperatively in an online game. In one embodiment, members 520 of a group 510 may be immersed in an online game such as a first person shooter game or a social game such as The Sims® or other network game. In another embodiment, members 520 of a group 510 could share statistics about their performance of a game and/or share the game itself

Members 520 of a group 510 may share any type of data. Examples of other types of data that may be shared include various types of media, payment information, a shopping cart, games, contact information, or any other type of data, including, without limitation, source or object code.

In some embodiments, membership in the group 510 or the groups 510 themselves may be time limited. For example, users of mobile devices 10 may wish to form a group 510 with the other mobile device users in close proximity with them at a certain time but would have no need for being a member 520 of that group 510 a short time later. In such an embodiment, the mobile device users may form a temporary group 510 for everyone to join. The length of time the group 510 exists may be predetermined or selected or specified by the person initiating creation of the group 510.

In some embodiments, groups 510 may be formed for a specific purpose or to accomplish a specific task. In one embodiment, a group 510 may be formed to split a bill between people. The bill may be for anything or any service. In one embodiment, a group 510 may be formed to split a restaurant bill by all or a portion of the people dining at the restaurant together. In one such embodiment, a single person (hereinafter “BillHolder”) may pay the entire bill with his/her credit card and wish to receive reimbursement payments from all or a portion of the other people (hereinafter “BillPayers”) dining at the table.

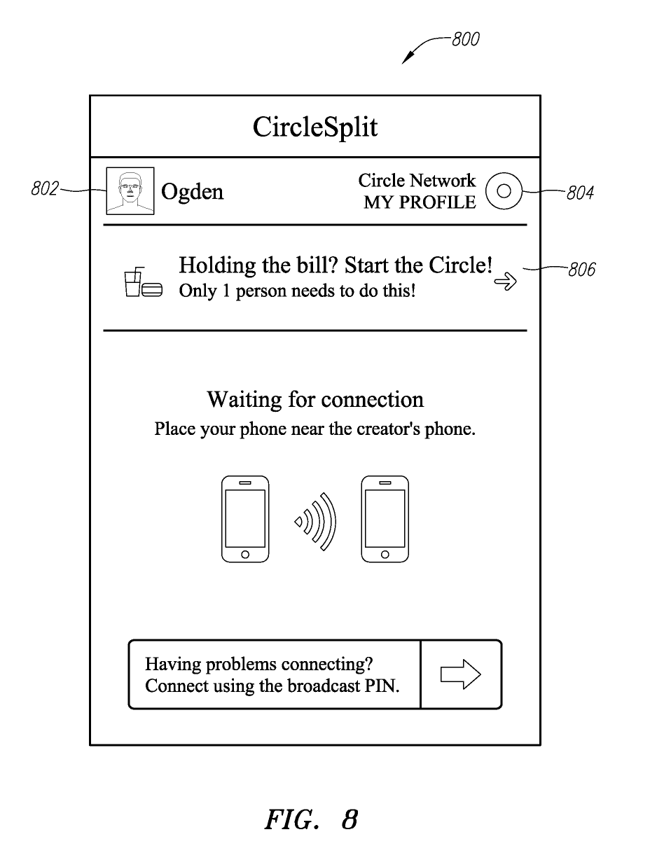

FIG. 8 illustrates one embodiment of an application initiation screen 800 for an application that may be used to split a bill. Both the BillHolder and the BillPayer may have the same application running on their mobile device 10. If the BillHolder or BillPayer is recognized by the application, they may already have a profile associated with their use. In some embodiments, profile information 802 may be automatically displayed by the application initiation screen 800. In addition, a link to the profile 804 or additional profile information may also be displayed. In one embodiment, further instruction to allow the BillHolder and the BillPayer to determine how to proceed may be provided. In the embodiment shown in FIG. 8, instructions in the form of a link 806 is provided to tell the BillHolder to initiate the transaction. As may be seen, additional instructions and links may also be provided by the application initiation screen 800.

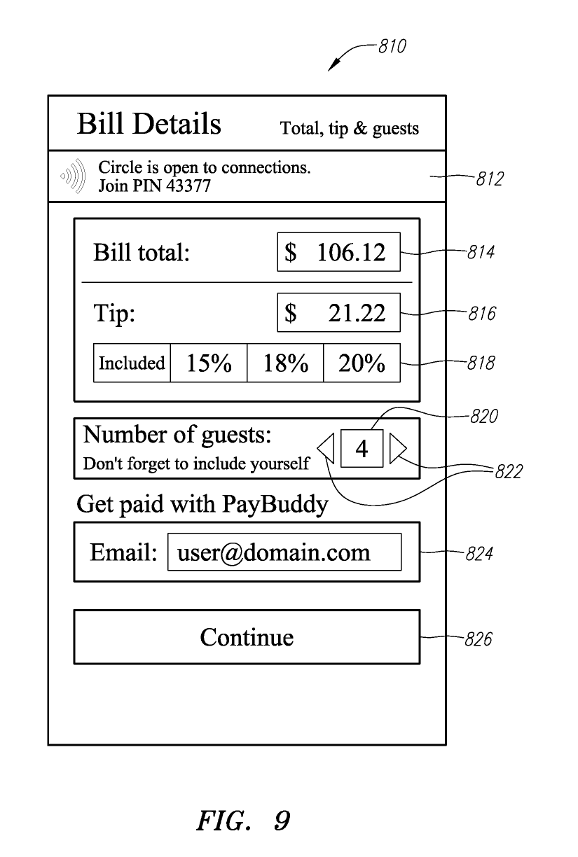

In the preferred embodiment, the BillHolder enters information about the bill or transaction into the application on his mobile device. FIG. 9 illustrates one example of a bill detail screen 810 to allow the BillHolder to enter information. The BillHolder may enter the amount of the bill 814, the size of the party 820, and payment information 824. Various controls may be included in screen 810 to facilitate the BillHolder's entry of the bill details. For example, arrows 822 may be used to allow the BillHolder to easily increment the number of guests 820. In some embodiments, tip information 816 may also be input by the BillHolder. The tip amount may be directly input by the BillHolder in box 816. However, in addition to tip box 816, as shown in FIG. 9, various tip percentages 818 such as 15%, 18% or 20% may be automatically selected. When a tip percentage 818 is selected by the BillHolder, tip box 816 may be automatically updated to the tip amount corresponding to the tip percentage by the application.

Payment information may be information that allows the BillHolder to receive money by any method. In the preferred embodiment, the BillHolder may enter his PayPal® email address 824. Although in FIG. 9 the BillHolder is only given the option to be paid using PayPal®, in other embodiments other methods of payment may be available. Moreover, in some embodiments the BillHolder may have a plurality of choices as to how to receive payment. If the BillHolder has used the application before, a default PayPal® email address or other payment information may be already entered, subject to any edits or changes by the BillHolder. Once all the bill information is entered by the BillHolder, the BillHolder may select the continue button 826 to continue the process.

In order to initiate splitting the bill, the BillHolder may initiate the creation of a group 510. Group 510 may be created before of after the bill details are entered by the BillHolder. In the embodiment shown in FIG. 9, the group is automatically created by the application before the BillHolder enters the bill information. As may be seen in FIG. 9, the bill detail screen 810 already has a PIN (43377) indicating a group has been formed. In the preferred embodiment, the PIN is an invitation code without any error bits or other information. In other embodiments the PIN may be some other unique number.

The group 510 is created by the BillHolder obtaining an invitation code 300 to form a group. In the preferred embodiment, the invitation code 300 is obtained by the mobile device 10 of the BillHolder sending a join request to a communication server 420. Once the invitation code 300 is obtained, the invitation code 300 is transformed into a sound wave signal 200 and transmitted by the speaker 30 of the mobile device 10 of the BillHolder.

One advantage to forming the group and obtaining the invitation code before the bill details are entered is that the BillHolder may begin transmitting the invitation code to the BillPayers prior to entering the bill details. This allows the BillPayers to be joined to the group and be ready to receive the bill details as soon as they are entered by the BillHolder.

In one embodiment, the BillPayers sitting at the table who wish to split the bill with the BillHolder open an application on their respective mobile devices 10 to listen for a sound wave signal 200. In the preferred embodiment, BillPayers see a similar screen to the one in FIG. 8. The screen may include some instructions such as “Waiting for Connection.” In a preferred embodiment, the application listening for a sound wave signal 200 may already be running in the background on the mobile devices 10 of the people sitting at the table.

The mobile devices 10 listening for a sound wave signal 200 detect the sound wave signal 200 being transmitted by the BillHolder with the microphones 30 on their respective mobile devices 10 and transform the sound wave signal 200 into the invitation code 300. In embodiments that include an invitation code 300 with error bits, the mobile devices may next verify the invitation code 300 is error free. If the invitation code 300 has errors, the code is ignored and the device continues to listen for a new invitation code 300. If the invitation code 300 is determined to be error free, the mobile devices 10 submit an add request including the invitation code 300 to the communication server 420 and are joined to the group 510 created by the BillHolder.

Although in the preferred embodiment, mobile devices 10 join a group through the use of an invitation code 300 encoded in a sound wave signal 200, in other embodiments users may join a group by simply typing the invitation code 300 number directly into their mobile device 10. Invitation code 300 may be in the form of a PIN. In the preferred embodiment, a PIN is an invitation code with any information which is not part of the data payload stripped out. In other embodiments the PIN may be another uniquely identifiable code or number other than the invitation code 300.

In one example, when a mobile device 10 obtains an invitation code 300, that invitation code 300 may not only be transmitted by the speaker 20 of the mobile device 10, but may also be displayed on the screen of the mobile device 10 that requested the invitation code 200. The invitation code 200 number may then be given to anyone that wants to join the group 510. People wishing to join the group 510 may then manually type the number of the invitation code 200 into their device to join the group 510. Among other applications, this embodiment can allow a group to include members whose mobile device 10 speaker is not properly functioning, or whose device is not then present.

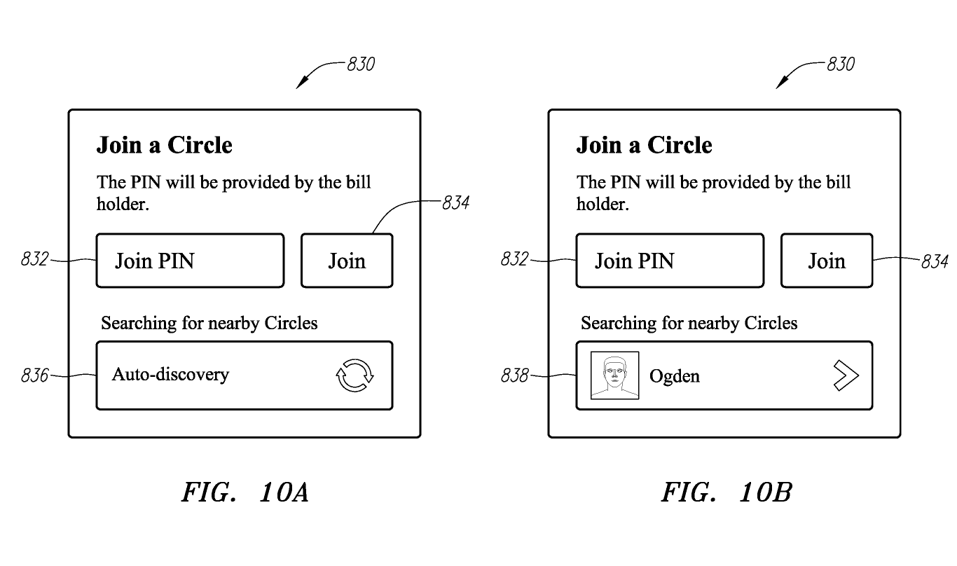

In some embodiments, the BillPayer may join the group by directly entering the PIN number into the application 800 to join the group 510. Part of the initial screen the BillPayer sees may include instructions to manually enter the PIN number or a link to an additional screen to manually enter a PIN number. FIG. 10A and 10B illustrate embodiments of PIN entry screens 830 that may be presented to a BillPayer such that the BillPayer may be able to manually enter a PIN to join a group. PIN entry screens 830 may include a join PIN entry box 832 and a join button 834 to allow the BillPayer to manually enter the PIN supplied by the BillHolder. The PIN entry screens 830 may further include group update information 836 and 838 such that if any groups are detected the BillPayer may continue the join process using sound wave signals instead of manually entering the PIN.

Once all the members at the table wishing to participate in paying the bill are joined in the same group 510, payment may be exchanged. In one embodiment, the BillHolder's payment information is transferred to the BillPayers automatically to facilitate paying the bill more easily. In the preferred embodiment, the BillHolder's PayPal® information is transferred to the BillPayers.

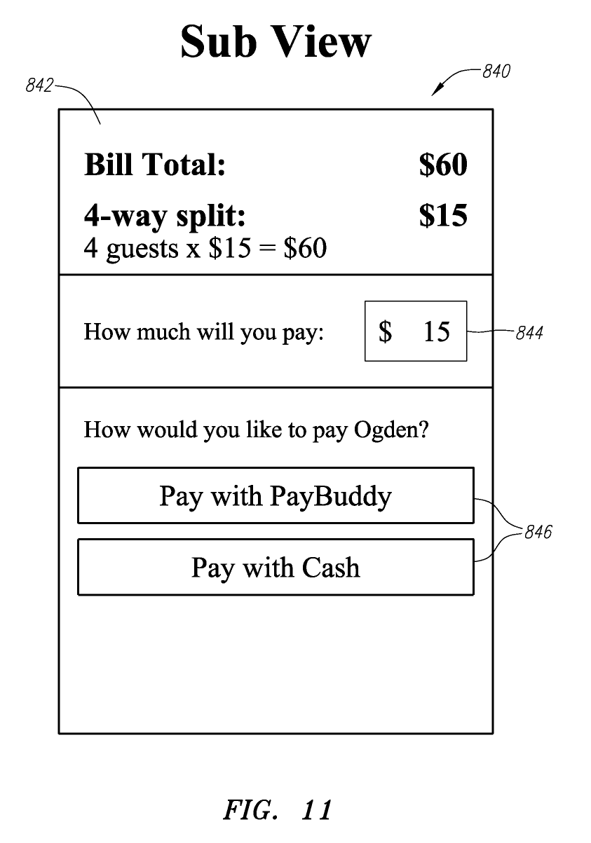

FIG. 11 illustrates one embodiment of a payment screen 840 a BillPayer may see once the BillPayer is joined to the group 510. Payment screen 840 may include various information about the bill 842. For example the bill information may include the bill total, the number of people splitting the bill, the tip amount, the amount owed by the BillPayer, the tax amount or any other information about the bill.

In some embodiments, payment screen 840 may include an editable payment amount box 844. The payment box 844 may include the amount of money the particular BillPayer owes the BillHolder by default. In embodiments where the box 844 is editable, the BillPayer may accept the default amount or change the amount.

In some embodiments, the BillPayers may have a choice of the method that they may use to pay the BillHolder. For example, the BillPayers may have a credit card or other payment method associated with their group 510 profile or may be able to enter a credit card number or banking account number into the application. In certain embodiments, BillPayers may have a choice of paying with the payment information sent by the BillHolder or using their own payment method. In some embodiments, BillPayers may also be able to elect to pay the BillHolder with cash. As shown in FIG. 11, payment screen 840 may include a number of buttons 846 which allow the BillPayer to select from various different payment methods.

Once the BillPayers selects the method of payment, the payment may be made. In some embodiments, the payment may be facilitated through the communication server 420. In one embodiment, the BillPayer(s) may enter the amount of money they wish to pay the BillHolder and that information may be transferred back to the communication server 420. The communication server 420 may then facilitate payment. In some embodiments payment may be made through a source associated with the BillPayer such as a credit card associated with the BillPayer's profile. In other embodiments, the payment may be made through a credit card number or banking number entered directly by the BillPayer. In still other embodiments, the payment may be made through a third party such as PayPal® or another payment provider.

In other embodiments, the payment method may be handled directly by the mobile device 10. For example, the application running locally on the mobile device 10 of the BillPayer may initiate payment with a third party payment provider such as PayPal®. In the preferred embodiment, the interface with PayPal® is integrated into the application running on the phone such that if a BillPayer selects PayPal®, the PayPal interface launches a login screen. In such an example, data about the transaction such as the identity of the BillHolder, BillPayer, and payment amount may be automatically transferred to the third party payment processor such as PayPal®. Importing data into the third party payment processor reduces the amount of information the BillPayer must enter in order complete the transaction with the BillHolder. This makes the transaction faster, safer, and more convenient for both the BillHolder and the BillPayer. In some embodiments, the payment is made automatically without further intervention by the BillPayer. In the preferred embodiment, the BillPayer is given a confirmation screen to confirm payment.

In some embodiments, the BillPayers may select to pay the BillHolder using other methods of payment. For example, the BillPayers may simply elect to give the BillHolder cash. The BillHolder may be notified that a BillPayer has elected to pay with an alternative payment method such as cash. In the preferred embodiment, the BillHolder may receive a pop-up window on his/her mobile device 10 notifying him/her that a BillPayer has elected to pay with an alternative method such as cash.

Once the BillPayer completes or confirms payment or elects to pay the BillHolder using some other method such as cash, the BillHolder's screen may receive alerts when he/she has been paid. For example, the BillHolder may receive an alert that he has received a payment to his PayPal® account.

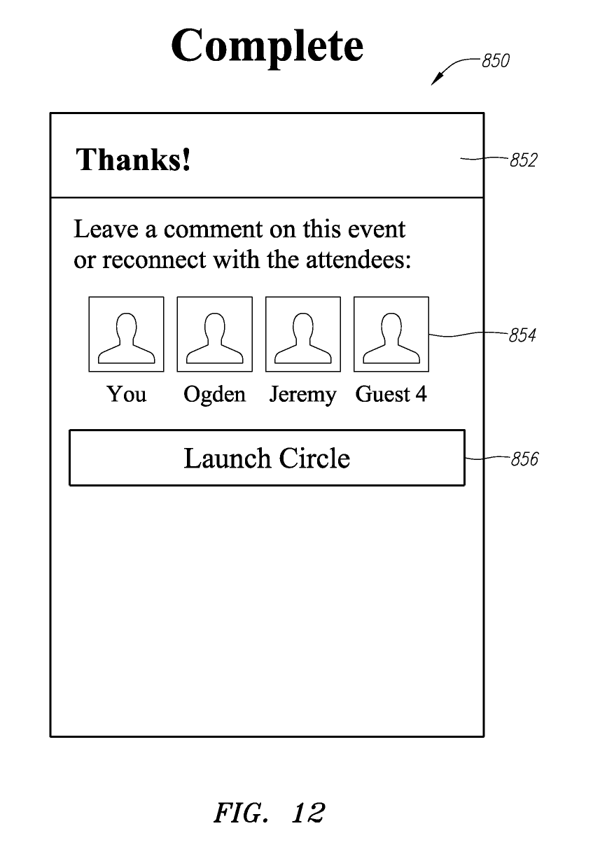

In some embodiments, the BillPayer may also receive a confirmation screen. FIG. 12 illustrates one embodiment of a confirmation screen 850. The confirmation screen may include a salutation 852 or in other embodiments may include information about the transaction that was just confirmed. The confirmation screen 850 may also include information about all the people involved in the transaction. For example, the confirmation screen 850 may include links to the BillHolder and other BillPayers profiles 854. In other embodiments, the confirmation screen may include a link or button to restart the application 856. In other embodiments, the confirmation screen 850 may include any other links or information that may be of use to the BillPayer.

In another embodiment, a group 510 may be used to create a shared shopping cart between a person or a business desirous of selling goods or services and customers desirous of obtaining such goods or services. Embodiments that create a shared shopping cart may be used to facilitate sales at a garage sale, trunk show, flee market, farmers market, food truck, retail store front, or anywhere that goods and services are exchanged.

An example of one embodiment of a shared shopping cart will now be explained with respect to a trunk show. In a trunk show, a host invites a retailer and a number of their friends into their home to provide a place for the retailer to display and sell their goods or services to the host and his/her friends (collectively hereinafter “shoppers”). Trunk shows are typically associated with jewelry and accessories but may be any item including candles, tools, collectables or other items of value or interest. In a trunk show, the retailer may send a salesperson that is knowledgeable about the product to teach or advise the shoppers on the products and keep track of the sales.

In such an embodiment, the salesperson may create a group 510 using the methods explained above and transmit an invitation code 300 to the shoppers. The shoppers may then be added to a group 510 that includes the salesperson. In one embodiment, once the shoppers and the salesperson are part of a group 510, they may have access to each others profile information to learn more about the attendees of the trunk show. In some embodiments, each shopper may have a shared shopping cart that is shared with the salesperson. In such an embodiment, both the shopper and the salesperson may be able to see the items in the shopping cart. In some embodiments, both the salesperson and the shopper may be able to add or remove items to the shopping cart. In other embodiments, only the shopper is able to add or remove items to the shopping cart but both the salesperson and the shopper may both view the items in the cart.

In some embodiments, payment functionality may also be added. In such an embodiment, the shopper may be able to pay the salesperson for the items. In addition, payment may be facilitated between the salesperson and the shopper similar to the exchange between the BillHolder and BillPayer explained above. In various embodiments, payment may occur through PayPal®, a credit card, cash or any other acceptable form of payment.

In some embodiments, the total of all the shopping carts and the total of all the payments made may be viewable to specific members 520 of the group 510. For example, in a trunk show, the host often gets a reward from the retailer of the goods that is commensurate with the total goods sold. Accordingly in some embodiments, the host and/or the salesperson may be able to see the totals of all the goods in the shopping carts of all the shoppers and the total of all the payments made by all the shoppers.

In some embodiments, after the trunk show is over, the group 510 may persist. Members 520 of the group 510 may continue to communicate with each other through a data network 410. Accordingly, members 520 may upload pictures, video or other media of themselves wearing or using the products they purchased at the trunk show for other members 520 to see. In addition, the salesperson may remain in contact with the shoppers after the trunk show is over.

In some embodiments, the salesperson may be able to provide deals or coupons to members 520 of a group 510 formed at a prior trunk show. The coupons or deals may be offered during the trunk show or afterwards. In one embodiment, coupons or sales might be offered in the middle of a trunk show. For example, based on the total sales the salesperson might wish to offer a time limited sale period or another type of incentive to encourage purchasing. In other embodiments, the coupons or sales may be offered to shoppers after the trunk show is over to encourage continued purchasing or to encourage another member of the group to host a trunk show.

Although in the preferred embodiment mobile devices 10 and their users join and participate in groups 510 via their mobile devices 10, users may also join and participate in groups 510 through a device directly connected to the data network 410. For example, a person may join a group 510 directly from their hard wired computer by typing the number of an associated invitation code 300 into a web interface. In addition, members 520 of group 510 may be able to view and edit their profiles via a web interface. The web interface may also be available via the screens of mobile devices 10 that are web enabled.

In another embodiment, radio stations may use sound wave signals to send additional data to their listeners' devices. For example, Radio Stations, both FM and AM, could send additional sound waves, in addition to the speech and music content. These sound waves could include additional information, such as details of the song and artist currently being played, radio station information, calendar of radio events, or information on the radio sponsors. For example, during a commercial break, information about the sponsor could be sent along and received by devices in proximity user's radio speaker. This information could be the sponsor's phone number, website URL, or other details.

Similar to radio stations, in other embodiments, televisions may also be used to send additional data to their viewers' devices. For example, a television channel may send additional sound waves, in addition to the speech and music content. These sound waves may include additional information about the television presentation or commercial. For example, a food channel may send along the recipe or website URL for the current recipe being presented on the channel. A television commercial for a product may send information on the product, a website URL, or a coupon.

In other embodiments, a location may transmit a list of services or offerings using sound wave signals. In one embodiment, A location, such as a bar or restaurant, may provide information on the current lunch special, happy hour deals, or the food menu using sound wave signals. This may be useful for a location that has offerings that change often, such as a restaurant that updates their food menu daily. A pizza restaurant may provide their menu and a link to their mobile website that allows the customer to place orders over the internet through their mobile phone. This may encourage the customer to place orders in the future using their mobile phone. In another embodiment, a museum may provide information on exhibits, activities, or events for the day. In yet another embodiment, a retailer may provide a link to their website with information on products.

In yet another embodiment, the methods and apparatuses described herein may be used for automation. For example, a device may send information to another device to turn on or off a light. In another embodiment, a device may communicate over sound waves with a device connected to a car to unlock the door or start the engine, similar to how cars might be unlocked using a remote control.

In other embodiments, the methods and apparatuses described herein may be used for notifications. For example, some restaurants provide restaurant pagers to notify customers when their table is ready or food order is ready. Rather than using a pager, the restaurant could inform their customers using sound waves broadcast to the customer's device. The device could then vibrate or otherwise inform the customer that their table is ready. In one embodiment of this type of notification, the restaurant and the customer may form a group as explained above to facilitate further communication. For example, the restaurant might form a group with the customer when the customer is talking with the hostess or at another entry point. The restaurant may then easily notify the customer when his table is ready. Furthermore, the restaurant may send the customer links to the menu, advertisements, coupons, entertainment, or even take their order while the customer waits for their table.

In another embodiment, sound wave signals may be used to create a custom interface for another device. For example, a television could provide information on the remote control user interface over sound waves to another device. The device could then use that information to create a user interface on the device's screen that the user could interact with for controlling the television. Once a connection is established, data may be exchanged between the device and the television using sound wave signals or a data network.

In yet another embodiment, the methods and apparatuses described herein may be used to transfer ticketing information to another device. Currently some airlines are providing paperless ticketing, where the customer scans a barcode of the ticket information when going through security and at the gate before boarding the plane. Instead of doing the scanning, embodiments of the present patent document may be used. For example, the customer may send sound waves to a device in the security line or to a device at the ticketing gate, which then provides the same ticketing information as the current scanning method. This same method may also be used with movie tickets, concert tickets, public transportation tickets, or other type of tickets. Data encryption may be used with any of these methods where needed to protect data.

In yet another embodiment, sound wave signals may be used to perform a location check-in. Services such as Foursquare®, Gowalla®, and Facebook® allow users to check-in (Social Check-In) to locations using their mobile phone. Users may be rewarded based upon the frequency or timing of their check-ins. For example, Foursquare® provides a Mayorship to the user who checks-in the most over a 60 day period. Venues can offer coupons, deals, or other rewards to users based upon the frequency of their patronage. These coupons, deals, or other rewards could also be sent to those customers who recently checked-in at the venue. One limitation of these services is the reliance upon GPS for location determination and verification. GPS is not always accurate indoors. In addition, users wanting to receive rewards can submit false check-ins to these services. With Foursquare®, it is possible to become the Mayor of a venue without ever being in proximity, by submitting false check-ins.

With embodiments described herein, it is possible to determine proximity of two devices and thus verify that a person is at a particular venue. In one embodiment, a user enters a venue. The venue has a speaker emitting a sound wave encoded with a unique key. The microphone on the user's mobile device receives this sound wave and submits the unique key to a service (such as a Foursquare® service) for verification. If the unique key submitted matches what the service expects, it is reasonably assumed that the user is at the venue.

In a second embodiment, the unique key is changed at a regular interval (e.g. every 12 hours). If the user visits and saves the unique key, it cannot be resubmitted on another occasion for an additional check-in, as it is only valid for a time window.

In a third embodiment, the unique key is regularly changed and only available for a single check-in by a single user. Once the user's device submits a check-in key to the service, a new unique key is pushed to the venue's speaker. This provides additional protection against multiple users using the same check-in key as would be possible with other embodiments.

Some embodiments, require that the device connected to the venue's speaker have internet connectivity when refreshing the unique key. In other embodiments, the device may be manually configured with a key that corresponds to a specific retail location. When the user enters the location, the speaker would pickup the sound wave signal and compare the key to the database of stored keys. In this way, the mobile device does not need a currently active internet location.

Another disadvantage of Foursquare® and similar services using GPS is that the user is not required to step inside a venue. They can often check-in as they walk past a venue. By using this invention, the user may be required to enter a venue and be within proximity of the speaker producing the unique check-in key. This may be advantageous to retailers who want customers to actually set foot into their stores.

In another embodiment, the methods and apparatuses of the present patent document may be used to provide a loyalty card service. Many retailers provide loyalty cards to encourage return customers. For example, hair salons may provide a punch card, where after paying for some number of haircuts, the next haircut is free. Also, at some hair salons, they might ask the customer for their phone number when they arrive, as to pull up the customer's details on a computer. Using the methods and apparatuses described herein, the customer could check-in with the computer using their device, instead of providing their phone number. After receiving the haircut, instead of punching a loyalty card, the information could be stored in the customer's account profile or sent to the customer's device. In the future, when the customer returns for the free haircut, upon check-in, the stylist will see the customer's profile and that they are due for a free haircut. The same type of system may be used for free sandwiches, at grocery stores instead of loyalty cards, or any other location where loyalty cards are used.

In addition to loyalty cards which may reward a customer based on the number of visits, retail stores may desire to provide an instant reward. Accordingly, in some embodiments, after checking-in at a retail location, the retailer may decide to provide a deal to those who have checked-in recently. This deal may show up on the customers' phones. It could be available for only a limited period of time. In addition, the retailer could provide a deal that would only go into effect if a certain number of customers decide to opt-in.

In yet another embodiment, devices may connect using sound wave signals to exchange identity information or as a form of travel card. These embodiments may replace physical cards, papers, or documents that people would normally carry around. In such an embodiment, data encryption may be used as explained above to keep the data secure.

In another embodiment, the methods of using sound wave signals described herein may be used for electronic keys, such as for unlocking a car, house, hotel room, or office.

In another embodiment, the methods and apparatuses described herein may be used to facilitate filling out forms. When arriving at a medical office for the first time, patients often need to fill out forms with their various medical and personal information. Patents often complete these forms using a pen, and the office clerk will then type that information into a computer. To save time for the patient and office clerk, this form could be provided to the patient in digital form to their device using the methods and apparatuses described above. The patient could have information populated into the form if it has already been saved on the device. After completing the form, the information could be sent securely to the office clerk and added to the system.

In other embodiments, the methods and apparatuses described herein may be used to provide a customer with a customized shopping experience. In one embodiment, the customer in one retail storey may be able to see comparable deals at other stores that sell similar products. In another embodiment, the customer may be provided with a better shopping experience at the store they are at. For example, the customer could be presented with highly targeted and customized deals based upon their previous shopping habits. Perhaps that customer visits the retailer often. Loyalty discounts could be given to the customer based upon previous purchases, or other items could be recommended to the customer. If the customer has a history of spending a lot of money (or simply buys items with large profit margins), sales staff may be notified that the customer is in the store and provide additional assistance.

In another embodiment, details about the store layout may be provided. The customer may browse and search for products located within the store. If the customer needs help, instead of walking around looking for someone to assist, the customer could touch a help button which could inform the sales staff to assist. By tracking this information, merchants could learn about customer behavior and make changes to improve the shopping experience.

To provide the customized shopping experience as described above, the merchant may use a customized shopping experience using any of the methods described above. For example, in some embodiments, a customized shopping experience may be combined with verified check-in or loyalty cards or a list of services or offerings.

In addition to customers using the methods and apparatuses described herein to communicate, in some embodiments the employees at the stores may also have applications running on their mobile devices or computers that use sound waves to communicate with the customers' devices. For example, a sales person could create a customized coupon or discount to a customer by sending it from his or her device to the customer's device.

In some embodiments, sound waves may be used to communicate from a website. For example, a website may have a button or link that plays a sound wave to transfer data through the computer speakers to the user's mobile device. In such an embodiment, a user might be looking at directions on Google Maps. Above the map, Google currently has a Send button. When pressed, this Send button presents options for sending a URL of the current map. These options currently include Email, Phone, Car, and GPS. The Phone option sends a text message to the user's device with a link to open the map on the phone. Another option could include a sound wave using this invention. The URL could be transferred in this manner to the user's phone.

In another embodiment, a user may send a URL from an online retail website to their phone. For example, a user might be browsing an electronics retail website for televisions. The user may read about the various televisions and choose to send the information on a few of the televisions to his mobile phone for when he visits the local retail store. In addition to the television information, a coupon may be sent that may save the user money when he visits the store. This coupon may be used as an incentive to the user to make the purchase while at that particular retail store, as opposed to buying at another retail location or window shopping at the retail store and then making the actual purchase online at a competing store.

In yet another embodiment, an online review site that uses affiliate programs to make money may provide a referral to a customer using the methods and apparatuses of the present patent document to receive referral credit for in-store purchases. For example, CNET, an online product reviews site, provides a section in their reviews for “Where to Buy”. In this section of the review, they provide links to various stores carrying a particular product they are reviewing. In the URL, they will often include their affiliate code, which generates a referral credit if the user who clicks on it ends up buying products at the site they are referred to. This type of affiliate program may be extended to purchase of items at physical stores. In addition to the affiliate code URLs, a website such as CNET, may send the product information and an affiliate code to the user's device using sound waves. The user may then use this information (and potentially a coupon or discount) at the physical store. Upon purchase, the retailer may provide referral credit to the website that referred the user.

The web to mobile embodiments described above may be extended to customer loyalty applications. For example, many merchants have loyalty programs to encourage repeat customer visits. As many merchants have both physical and online presence, the methods and apparatuses described herein may be used to integrate the customer loyalty program, so that the customer mey receive benefit for both shopping at a physical store location, as well as shopping on the merchant's website.

As described above, the website could send a loyalty voucher to the user's mobile device using sound waves after the user makes a purchase online. When the user visits a physical store and makes a purchase, the point of sale system may send a loyalty voucher to the user's device using this invention. This loyalty voucher may be any type of tracking of a customer's shopping visits, similar to how some punch or stamp a card after a purchase or visit.

In another embodiment, a customer visiting a store may receive a Referral Code from a device at the store. The customer may then send this Referral Code to someone else using sound waves or another mechanism. The recipient of the Referral Code may then redeem the code at the store (or at the merchant's website) for a discount on a purchase. The customer who sent the Referral Code may receive some form of compensation or discount on purchases for the referral. This may add value to retailers because shoppers may notice items in stores that may be of valuable to one of their friends. For example, a customer could be walking through a clothing store and notice a shirt that her friend might like. She may get a Referral Code (using sound waves, other mechanism, or combination thereof) and send along to her friend via any of the various mechanisms described here.

In another embodiment, OAuth may be used in conjunction with the embodiments disclosed herein. Many websites provide the ability to login using OAuth. Sites such as Facebook® allow this authentication mechanism to be used on other sites, so that users can use their Facebook® credentials to login to other websites. This type of credential exchange may be applied to the embodiments of the present patent document. In an embodiment that integrates OAuth, a website, such as Facebook®, viewed on a laptop, may have a button that played a sound wave that is received by a mobile device. The application running on the mobile device could then send an OAuth request over the internet to Facebook®. The website, viewed on the laptop, may then pop up an authorization screen asking the user if they wish to allow login (including potentially sharing Facebook® profile information) to the application on the mobile device. After the user allows access, the confirmation is sent over the internet to the application running on the mobile device, which is then logged in using the OAuth credential.

This type of functionality may be useful to the user, as typing login information on mobile devices may take longer than on a laptop or desktop computer keyboard. In addition to OAuth, other types of credentials may be exchanged between devices using a similar method.

It should be appreciated that the embodiments disclosed herein may be implemented in numerous ways, including as a process, an apparatus, a system, a device, a method, a computer readable medium such as a non-transitory computer readable storage medium containing computer readable instructions or computer program code, or as a computer program product comprising a computer usable medium having a computer readable program code embodied therein.

The embodiments of the present patent document may be packaged in software development kits (SDKs) for application on various platforms, including iOS, Android, Windows Phone, Blackberry, Nokia, Windows, Mac OSX, and Linux. The software for handling the transmission and receipt of the data over sound waves (as described herein) may be written in a cross platform language, such as C or C++. This software may be compiled into a core transformation library for distribution.

To address the unique aspects of each operating system (e.g., accessing the audio hardware), another layer of code could wrap around the library. For example, on the iPhone, which runs the iOS platform, a layer of platform specific code written in Objective-C, C, and/or C++ could wrap the core transformation library. This platform specific code could handle the calls to the Core Audio APIs (including registering for the callbacks) of the iOS SDK, as well as provide logging and any user interfaces. For the Android OS, this platform specific code may be written in Java and the core transformation library could be packaged using the Android Native Development Kit (some platform specific code could be written in C/C++ within the NDK to address latency of the Java Native Interface). Similar packaging could be done for the other platforms, where the core transformation library is wrapped by platform specific code to handle the hooks into the audio hardware APIs, logging, and user interfaces.

Depending on the capabilities of the platform and the underlying hardware, parameters may be set to improve performance. For example, the length of the digital filter could be increased if the device has more computational power. If there are deficiencies in the speaker's frequency response at the frequency band used by this invention, digital filters could be designed to compensate. Various parameters may be adjusted to configure such filters.

In addition to data exchange using sound waves, in some embodiments the SDKs could support other technologies, such as NFC, Bluetooth, and zeroconf. The API methods could abstract the actual technology being used for the communication with another device. For example, if Device A and Device B are both NFC capable, the SDK could choose to send data over NFC. If Device A has NFC but Device B does not, then the data could be sent using this invention. By providing support for multiple communication technologies, the SDK could choose the one that is most appropriate for the occasion. The SDKs could be integrated directly into the operating system. For example, some embodiments may be integrated directly into the Android OS for use in communicating with other devices. The API methods may abstract the technology used for sending the data as described above.

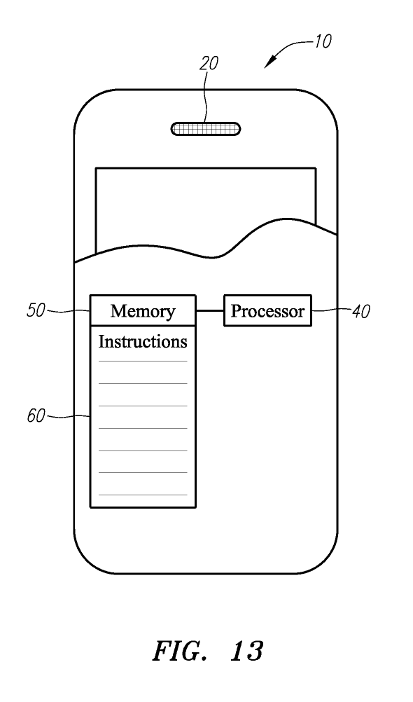

To this end, embodiments may be in the form of a set of computer instructions designed to be executed on a mobile device 10. FIG. 13 illustrates one embodiment of a mobile device 10 for use with the methods and apparatuses of the present patent document. The mobile device 10 includes a processor 40. The processor 40 carries out the instructions of the computer program, and is the primary element carrying out the functions of the mobile device and/or the program or software running on the mobile device. The processor 40 may also be the central processing unit (CPU) or may be an additional processor located on the mobile device 10. The processor 40 may be a microprocessor, microcontroller, digital signal processor (DSP), application specific integrated circuit (ASIC), field programmable gate array (FPGA), or any other type of processor. Examples of processors include but are not limited to Pentium Processors from Intel, or the AMD64 from AMD, or various ARM microprocessors to name a few. In certain embodiments, the mobile device may include more than one processor. When more than one processor is present, each processor may be dedicated to performing specific tasks. In other embodiments, the processors may share tasks.

The mobile device 10 also includes memory 50. Memory 50 is in communication with a processor 40. Memory 50 may be read only memory (ROM) or random access memory (RAM) or any combination thereof. Examples of memory 50 include but are not limited to DRAM, SRAM or flash memory. In some embodiments, memory 50, or some portion thereof, may be integrated with the processor 40.

The mobile device 10 further includes a set of instructions 60. The set of instructions 60 may include embodiments of the present patent document. The set of instructions 60 may also be referred to as software, a software program, code, computer readable code, or any other name. The memory 50 stores the set of instructions 60 executable by the processor 40, and/or data used by a software program run by the processor 40. The set of instructions 60 may be stored in non-volatile memory such as (ROM) or solid state memory so that the set of instructions 60 are not affected if the mobile device 10 is to lose power for a period of time. In some embodiments, the set of instructions 60 may also include an operating system and numerous mobile applications designed to run on the mobile device 10. In certain embodiments, the set of instructions may also be a web page or other application not specifically designed to run only on mobile devices.

In various embodiments, the steps of the methods of some of the embodiments disclosed herein may be performed when the processor 40 executes the set of instructions 60 residing in the memory 50 of the mobile device 10.

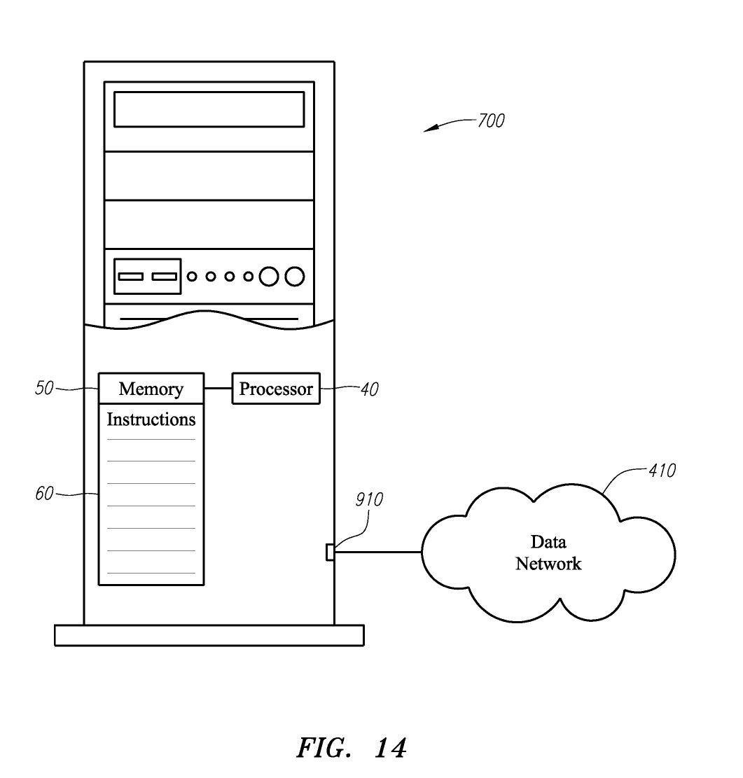

FIG. 14 illustrates a server 900. In a preferred embodiment, the communication server 420 is a server 900. Server 900 includes a processor 40, memory 50, and instructions 60. In addition, server 900 includes a network connection 910 that connects server 900 to a data network. The network connection 900 may be wired or wireless and may include various technologies and sizes.

Processor 40, memory 50, and instructions 60 residing on server 90 have a similar relationship to each other as described above with respect to mobile device 10. To this end, in various embodiments, the steps of the methods of some of the embodiments disclosed herein may be performed when the processor 40 executes the set of instructions 60 residing in the memory 50 of the server 900.

Although FIGS. 1 and 4 depict sound waves travelling through the air, there is no requirement that the sound waves travel through air. In some of the embodiments disclosed in the present patent document, the sound wave signals 200 may be transferred over a cable or wire(s).

In one embodiment, two devices may be connected together using an audio cable or wire(s) between the devices' audio ports. As just one example, the audio port of a payment receiving device may be directly connected to the headphone jack of a mobile phone. Using a cable or wire(s) allows both devices to transmit and receive data at the same time (full duplex). Device A may send data through the right/left speaker out while device B may receive through its microphone in and vice-versa. Furthermore, while it may be desirable to use an inaudible spectrum for transfer through the air, transferring over a cable or wire(s) may use the entire audio spectrum in some embodiments. In addition, far less error correction would be needed because the audio cable or wire(s) would not have the background noise perceived by devices transmitting through the air.

In one exemplary embodiment of two devices using a cable or wire(s) to communicate using a sound wave signal 200, a first device may be a payment terminal owned by a merchant, such as one made by Verifone. The payment terminal has an audio port or may be modified to include an audio port or jack. The audio jack is connected to a cable that terminates in a TRRS connector or other type of connecter compatible with the headphone jack of a standard mobile phone. If a user wishes to exchange funds with the merchant the user may simply connect the headphone jack of his mobile phone to the audio jack of the payment terminal via the cable or wire(s) and run an application that exchanges funds similar to the methods described above. The payment terminal would run compatible software to allow the payment terminal to receive or process the payment information via the audio jack from the mobile device.

Different devices may have different pin layouts for their audio jacks. The audio jacks (TRRS connector) for mobile devices have a layout of 4 pins on the jack/tip: right speaker, left speaker, microphone, and ground. The iPhone® and most Android® devices use a one pin layout. Some devices swap the positioning of the pins. In order to accommodate various audio jack designs, in some embodiments the payment machine may be designed to work with a specific audio jack connector design. However, in other embodiments the payment machine may be able to accommodate multiple audio jack designs. For example, the payment terminal may have more than one type of cable to support various audio jacks. Preferably, the payment machine has an audio port that can swap the positioning of the microphone and ground, or theoretically just listen on both pins in order to support multiple audio jack designs.

Using a cable or wire(s) may be a more secure method over transmitting sound wave signals through the air. Furthermore, because the user is plugging in through the audio jack and not a USB or 30-pin dock connector (as available on the iPhone®), there is a reduced risk of a malicious device hacking the phone. The risk of hacking or stealing data is reduced because the payment terminal is only dealing with an application using the audio jack and has no accessibility to other phone functions or data.

If one of the devices does not have an Internet connection (3G, WiFi, ethernet, etc.), that device could tunnel through the other device which has an Internet connection. For example in one embodiment, the mobile device may tunnel through the payment terminal. In another example, the payment device may tunnel through the mobile device. Tunneling may be accomplished using IP tunneling or any other method of tunneling. Tunneling may be useful for authenticating with a payment provider or credit card company without providing sensitive credentials to the other device, as the connection tunnel would be encrypted end-to-end.

What is claimed is:

1. A method of communicating between at least two mobile devices, the method comprising the steps of:
obtaining an invitation code at a first mobile device;
transforming the invitation code into a sound wave signal designed to be transmitted by the first mobile device; and
transmitting the sound wave signal from the first mobile device to a second mobile device.

2. The method of claim 1, further comprising the step of requesting the invitation code from a communication server.

3. The method of claim 1, wherein the invitation code is an invitation to a group including at least one other mobile device.

4. The method of claim 3, further comprising the step of receiving data from a mobile device in the group over a data network.

5. The method of claim 3, further comprising the step of transmitting data to a mobile device in the group over a data network.

6. The method of claim 4, wherein the data is routed through a communication server.

7. The method of claim 1, wherein the invitation code is valid for a limited time.

8. The method of claim 3, further comprising the step of receiving a payment over a data network from another mobile device in the group.

9. The method of claim 3, further comprising the step of transmitting a payment over a data network from another mobile device in the group.

10. The method of claim 8, wherein the payment relates to a restaurant bill.

11. The method of claim 1, wherein the sound wave signal is transmitted from the first mobile device to the second mobile device over a cable or wire.

12. A method of facilitating communication between at least two mobile devices, the method comprising the steps of:
receiving a join request from a first mobile device to join an additional mobile device to a group;
creating an invitation code designed to be transformed into a sound wave signal; and
sending the invitation code to the first mobile device.

13. The method of claim 12, further comprising the step of receiving an add request to add an additional mobile device to the group.

14. The method of claim 13, wherein the add request includes the invitation code.

15. The method of claim 13, further comprising the step of receiving a plurality of add requests from a plurality of mobile devices wherein each add request includes the invitation code.

16. The method of claim 12, wherein the invitation code is an invitation to the group which includes at least the first mobile device.

17. The method of claim 13, further comprising the step of adding an additional mobile device to the group.

18. The method of claim 16, further comprising the step of routing data over a data network from the first mobile device to the additional mobile device.

19. The method of claim 17, wherein the data includes payment information.

20. The method of claim 19, wherein the payment information relates to a restaurant bill.

21. A mobile device comprising:
one or more processors;
memory in communication with one or more processors;
a speaker in communication with one or more processors; and
a set of instructions residing in the memory and executable by one or more processors, wherein executing the set of instructions causes the speaker to transmit a sound wave signal that includes an invitation code, inviting communication with another device.

22. The mobile device of claim 21, wherein executing the set of instructions further causes a request for the invitation code from a communication server.

23. The device of claim 21, wherein the invitation code is an invitation to a group including at least one other mobile device.

24. The device of claim 23, wherein executing the set of instructions further causes the mobile device to receive data from another mobile device in the group over a data network.

25. The device of claim 23, wherein executing the set of instructions further causes the mobile device to transmit data to another mobile device in the group over a data network.

26. The device of claim 23, wherein executing the set of instructions further causes the mobile device to receive a payment over a data network from another mobile device in the group.

27. The device of claim 23, wherein executing the set of instructions further causes the mobile device to transmit a payment over a data network to another mobile device in the group.

28. A network computer comprising:
one or more processors;
memory in communication with one or more processors;
a network connection in communication with one or more processors; and
a set of instructions residing in the memory and executable by one or more processors, wherein executing the set of instructions, causes the processor to:
create a group including a first mobile device;
create an invitation code designed to be transformed into a sound wave signal; and
transmit the invitation code to the first mobile device.

29. The network computer of claim 28, wherein executing the set of instructions further causes one or more processors to add a second mobile device to the group when an add request including the invitation code is received.

30. The network computer of claim 28, wherein executing the set of instructions further causes the network computer to route data over a data network from the first mobile device to the second mobile device.

31. The network computer of claim 30, wherein the data includes payment information.
